(19) United States
(12) Patent Application Publication
(10) Pub. No.: US 2006/0085280 A1
(43) Pub. Date: Apr. 20, 2006

(54) Internet search engine with integrated e-commerce functionality

(76) Inventors: Dan Murnan, Mukilteo, WA (US); Daniel L. Porter, Portland, OR (US); W. Travis Cox, Edmonds, WA (US)

Correspondence Address: Olympic Patent Works PLLC, P.O. Box 4277, Seattle, WA, 98194-0277, US

(21) Appl. No.: 11/236,219

(22) Filed: Sep. 27, 2005

Related U.S. Application Data
(60) Provisional application No. 60/613,245, filed on Sep. 27, 2004.

(51) Int. Cl. G06Q 30/00; G06F 17/30

(52) U.S. Cl. 705/26; 707/3; 705/37

(57) ABSTRACT

Various embodiments of the present invention are directed to an Internet search engine with e-commerce functionality (“e-commerce search engine”). In one embodiment of the present invention, users can use the e-commerce search engine to locate retail items by typing in a key-word search. The search results displayed by the e-commerce search engine are vendor-website listings for vendors that sell retail items related to search terms. Some vendor-website listings may contain quick links through which a user can shop for, and purchase, retail items from the vendor through the e-commerce search engine, without being re-directed to the vendor's website. Transaction information is later relayed from the e-commerce search engine to the vendor. The vendor can then confirm the order and the shipping information with the user and complete the transaction.

### CROSS-REFERENCE TO RELATED APPLICATION

This application claims the benefit of Provisional Application No. 60/613,245, filed Sep. 27, 2004.

### TECHNICAL FIELD

The present invention relates to the field of Internet search engines, and, in particular, to an Internet search engine with e-commerce functionality.

### BACKGROUND OF THE INVENTION

The rising popularity of electronic commerce (“e-commerce”) over the Internet has created a demand for increased efficiency in locating websites through which goods and/or services (“retail items”) are sold. Currently, consumers interested in making purchases of various retail items over the Internet type key words into search engines to locate businesses that engage in e-commerce (“vendors”). Key-word searches can often yield an enormous number of search results in the form of links to various websites and on-line postings. When a user is using a key-word search to locate retail items, a number of the displayed search results are often unwanted. For example, some of the displayed search results, generally website links, may be unrelated, or may only be peripherally related to the search query. Commonly-used words contained within key-word-search queries often can elicit a large number of unwanted search results to be displayed, since commonly-used words are frequently included in many different web pages.

Consider a user who desires to find and purchase a specific retail item over the Internet. The user may locate a search engine and enter a key-word search. For example, a user desiring to find golf shoes in the Seattle area may type the words “Seattle Golf Stores” into the search engine. The Search engine may display an expansive number of search results. The user may then need to spend a large amount of time scrolling through the numerous pages of resulting website links, many of which may contain information that bears no relevance to locating golf stores in the Seattle area. Some of the unrelated website links may be eliminated by a quick inspection of displayed annotations describing the website links. For example, an annotated search result describing a retail lot for sale on Seattle Street in Plano, Tex. would most likely not be considered by the user to be relevant to a search for golf stores in Seattle, Wash.

However, sometimes the relevance of a search result can only be determined by clicking on a website link to display the website. For example, a search result containing a website link to a local magazine review of regional golf stores may or may not contain relevant retail information for a user seeking golf stores in the Seattle area. The user may need to review the website to determine whether or not the website is relevant or not. A user often needs to sift through multiple pages of information before the user can determine the relevance of a website addressed by a link returned as a search result. Once the relevance of the website is determined, the user may need then to identify whether or not retail items are sold on the website, and whether or not the website carries the specific type of retail item the user desires to purchase. The Internet-based purchasing process can be time consuming and annoying for users. E-commerce users and e-commerce vendors have, therefore, recognized a need for a way to streamline e-commerce transactions between a user and a vendor to make e-commerce transactions simpler, more efficient, and more reliable.

### SUMMARY OF THE INVENTION

Various embodiments of the present invention are directed to an Internet search engine with e-commerce functionality (“e-commerce search engine”). In one embodiment of the present invention, users can use the e-commerce search engine to locate retail items by typing in a key-word search. The search results displayed by the e-commerce search engine are vendor-website listings for vendors that sell retail items related to search terms. Some vendor-website listings may contain quick links through which a user can shop for, and purchase, retail items from the vendor through the e-commerce search engine, without being re-directed to the vendor's website. Transaction information is later relayed from the e-commerce search engine to the vendor. The vendor can then confirm the order and the shipping information with the user and complete the transaction.

### BRIEF DESCRIPTION OF THE DRAWINGS

FIG. 1 shows the interconnection of a user and a vendor through a web server for an e-commerce search engine that represents one embodiment of the present invention.

FIG. 2 shows a control-flow diagram of actions taken by a user purchasing retail items via an e-commerce search engine that represents one embodiment of the present invention.

FIG. 3 shows an exemplary home page for an e-commerce search engine that represents one embodiment of the present invention.

FIG. 4A shows an exemplary home page for an e-commerce search engine that displays search results for a query that represents one embodiment of the present invention.

FIG. 4B shows an exemplary home page for an e-commerce search engine that includes search results for golf courses with quick links and that represents one embodiment of the present invention.

FIG. 5 shows an exemplary tee-times page, accessed via a quick link included in a vendor-website listing displayed as a search result by an e-commerce search engine that represents one embodiment of the present invention.

FIG. 6 shows an exemplary transaction page, displayed subsequent to the selection of a retail item for purchase, by an e-commerce search engine that represents one embodiment of the present invention.

FIG. 7 shows an exemplary pro-shop page, accessed via a quick link included in a vendor-website listing displayed as a search result by an e-commerce search engine that represents one embodiment of the present invention.

FIG. 8 shows an exemplary coupons page, accessed via a quick link included in a vendor-website listing displayed as a search result by an e-commerce search engine that represents one embodiment of the present invention.

FIG. 9 shows an exemplary hot-times page, accessed via a quick link included in a vendor-website listing displayed as a search result by an e-commerce search engine that represents one embodiment of the present invention.

FIG. 10 shows an exemplary events page, accessed via a quick link included in a vendor-website listing displayed as a search result by an e-commerce search engine that represents one embodiment of the present invention.

FIG. 11A shows a control-flow diagram of exemplary actions taken by a business registering as a vendor to sell retail items via an e-commerce search engine that represents one embodiment of the present invention.

FIG. 11B shows a control-flow diagram of exemplary actions taken by a premium vendor during a sales event via an e-commerce search engine that represents one embodiment of the present invention.

FIG. 12A shows an exemplary on-line registration page for a basic vendor-website listing displayed by an e-commerce search engine that represents one embodiment of the present invention.

FIG. 12B shows the first page of an exemplary on-line registration process for a premium vendor-website listing displayed by an e-commerce search engine that represents one embodiment of the present invention.

FIG. 13 shows the second page of an exemplary on-line registration process for a premium vendor-website listing displayed by an e-commerce search engine that represents one embodiment of the present invention.

FIG. 14 shows the third page of an exemplary on-line registration process for a premium vendor-website listing displayed by an e-commerce search engine that represents one embodiment of the present invention.

FIG. 15 shows the fourth page of an exemplary on-line registration process for a premium vendor-website listing displayed by an e-commerce search engine that represents one embodiment of the present invention.

FIG. 16 shows the fifth page of an exemplary on-line registration process for a premium vendor-website listing displayed by an e-commerce search engine that represents one embodiment of the present invention.

FIG. 17 shows an exemplary vendor-login page that a premium vendor can use to access a vendor-control menu displayed by an e-commerce search engine that represents one embodiment of the present invention.

FIG. 18 shows an exemplary vendor-website-listing management page displayed by an e-commerce search engine that represents one embodiment of the present invention.

FIG. 19 shows an exemplary vendor-control-menu home page that a premium vendor can use to manage a premium vendor-website listing displayed by an e-commerce search engine that represents one embodiment of the present invention.

FIG. 20 shows an exemplary general settings page which a premium vendor can use to change general settings for a premium vendor-website listing displayed by an e-commerce search engine that represents one embodiment of the present invention.

FIG. 21 shows an exemplary billing page that allows a premium vendor to manage budgetary information for a premium vendor-website listing with an e-commerce search engine that represents one embodiment of the present invention.

FIG. 22 shows an exemplary web-specials page that allows a premium vendor to manage web specials displayed in association with a premium vendor-website listing by an e-commerce search engine that represents one embodiment of the present invention.

FIG. 23 shows an exemplary hot-times page that allows a premium vendor to manage hot times displayed in association with a premium vendor-website listing by an e-commerce search engine that represents one embodiment of the present invention.

FIG. 24A shows an exemplary e-commerce-main-page that allows a premium vendor to manage retail items displayed within a pro shop page on a premium vendor-website listing by an e-commerce search engine and that represents one embodiment of the present invention.

FIG. 24B shows an exemplary e-commerce-main page that allows a premium vendor to manage retail items displayed, on either a pro shop page or an events page, in association with a premium vendor-website listing by an e-commerce search engine and that represents one embodiment of the present invention.

FIG. 25 shows an exemplary pro-shop-managing page that allows a premium vendor to manage retail items displayed on a pro shop page in association with a premium vendor-website listing by an e-commerce search engine that represents one embodiment of the present invention.

FIG. 26 shows an exemplary events-managing page that allows a premium vendor to manage retail items displayed on an events page in association with a premium vendor-website listing by an e-commerce search engine that represents one embodiment of the present invention.

FIG. 27 shows an exemplary retail-item-addition-and-management page that allows a premium vendor to add and manage retail items displayed on a pro shop page in association with a premium vendor-website listing by an e-commerce search engine that represents one embodiment of the present invention.

FIG. 28 shows an exemplary list of people ordering retail items via a premium vendor-website listing displayed by an e-commerce search engine that represents one embodiment of the present invention.

FIG. 29 shows an exemplary pro-shop-settings-managing page that allows a premium vendor to manage selected settings for a pro shop associated with a premium vendor-website listing displayed by an e-commerce search engine that represents one embodiment of the present invention.

FIG. 30 shows an exemplary statistics page that allows a premium vendor to view the number of click-throughs and transactions occurring on a premium vendor-website listing displayed by an e-commerce search engine that represents one embodiment of the present invention.

### DETAILED DESCRIPTION OF THE INVENTION

Various embodiments of the present invention are directed to an e-commerce search engine with e-commerce functionality (“e-commerce search engine”). The search engine runs on a web server that received requests for html files from a web browser. Requests by the web browser may or may not include user-input requests embedded in the request. The search engine parses the request and generates subsequent html files based on the request.

The e-commerce search engine allows users to engage in vertically-directed searches for retail items. A vertically-directed search allows users to create search queries, locate vendors, and perform business transactions with the located vendors, via the e-commerce search engine, without being re-directed to a vendor website. The e-commerce search engine can also limit returned search results to only vendor-website listings of retail-related items within the subject matter of the search query.

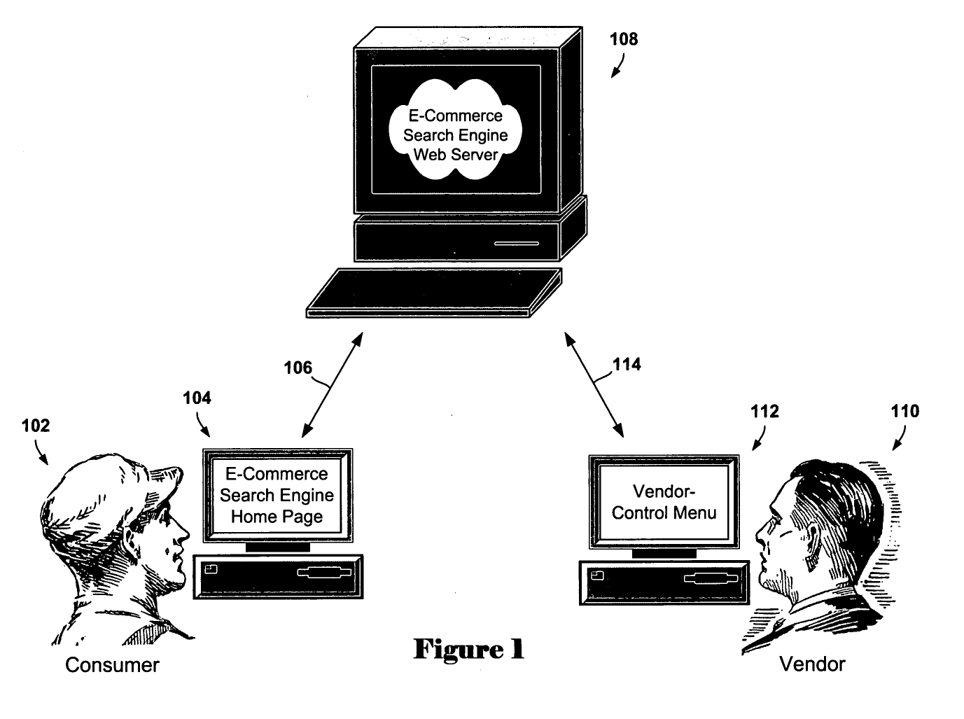

FIG. 1 shows the interconnection of a user and a vendor through a web server for an e-commerce search engine that represents one embodiment of the present invention. A user 102 can log on to an e-commerce search engine home page 104 and create a key-word search to locate retail items. The key-word search is transmitted, as shown by two-way arrow 106, to a web server for the e-commerce search engine108. The web server for an e-commerce search engine108 can transmit back to the user 102 search results for the search terms used.

A vendor 110 can log on to a vendor-control menu 112. From the vendor-control menu 112, the vendor 110 can transmit information to the web server for an e-commerce search engine108, as shown by two-way arrow 114, to add, manage, and/or remove retail items listed for sale via one or more quick links included on a vendor-website listing. The web server for an e-commerce search engine108 can transmit information back to the vendor 110, including displaying vendor-website listing updates.

When a user 102 enters a key-word search to look for a retail item, the web server for an e-commerce search engine108 displays annotated search results to the user 102 in the form of vendor-website listings. Each vendor-website listing contains a website link that, when clicked, displays a vendor website that sells retail items related to the search terms used by the user 102. Some vendor-website listings additionally contain quick links. When a user 102 clicks on a quick link, one or more pages are displayed that list and describe a particular type of retail items that are listed for sale from the vendor 110. The listed retail items can be purchased by the user 102 through the web server for the e-commerce search engine108, without being re-directed to the vendor's website.

Subsequent to selecting a retail item for purchase, the user 102 can input billing and shipping information to the web server for the e-commerce search engine108. Once the billing and shipping information is complete, the web server for the e-commerce search engine108 alerts the vendor 110 of the transaction. The vendor 110 then logs on to the vendor-control menu 112 and accesses the billing and shipping information from the web server for the e-commerce search engine108. Once the vendor 110 receives the billing and shipping information, the vendor 110 can confirm the order with the user 102 and complete the order.

The present invention is described in more detail below in the following two subsections: (1) the user's perspective, and (2) the vendor's perspective.

### The User's Perspective

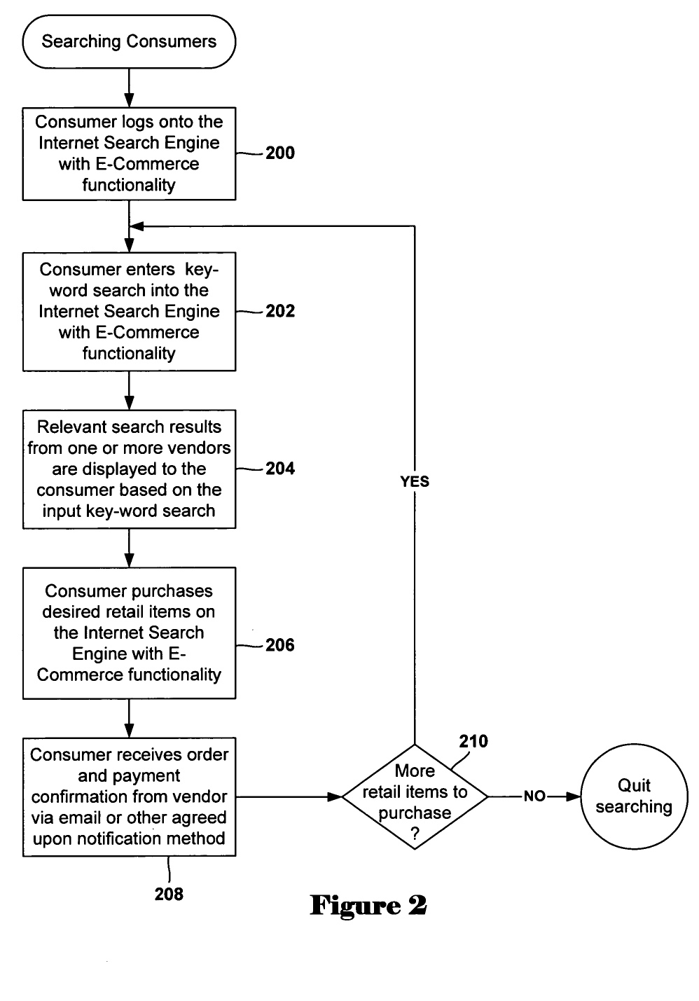

FIG. 2 shows a control-flow diagram of actions taken by a user purchasing retail items via an e-commerce search engine that represents one embodiment of the present invention. In step 200, a user logs onto the e-commerce search engine. In step 202, the user performs a key-word search to locate retail items. In step 204, relevant vendor-website listings are displayed for both premium vendors and basic vendors. In step 206, the user purchases a retail item from a premium vendor. The user selects a retail item and enters transactional data, such as billing and shipping information, via the e-commerce search engine. The input information is relayed to the premium vendor. In step 208, confirmation of the transaction is received from the premium vendor by email, or other mutually-agreed-upon method. In step 210, when the user purchases additional retail items, control is passed to 202. Otherwise, the user quits searching for retail items via the e-commerce search engine.

The e-commerce search engine can be adapted to function specifically within a particular industry or type of retail item. For example, the e-commerce search engine can be designed to serve the golf industry. For a golf-directed Internet E-commerce search engine, likely candidates for businesses desiring to become vendors are golf-based industries, including golf courses, golf equipment, golf supplies, golf training and education, and other golf-based industries. Likewise, golf enthusiasts may comprise a large portion of the users frequenting the golf-directed E-commerce search engine to browse for, and purchase, golf-related retail items.

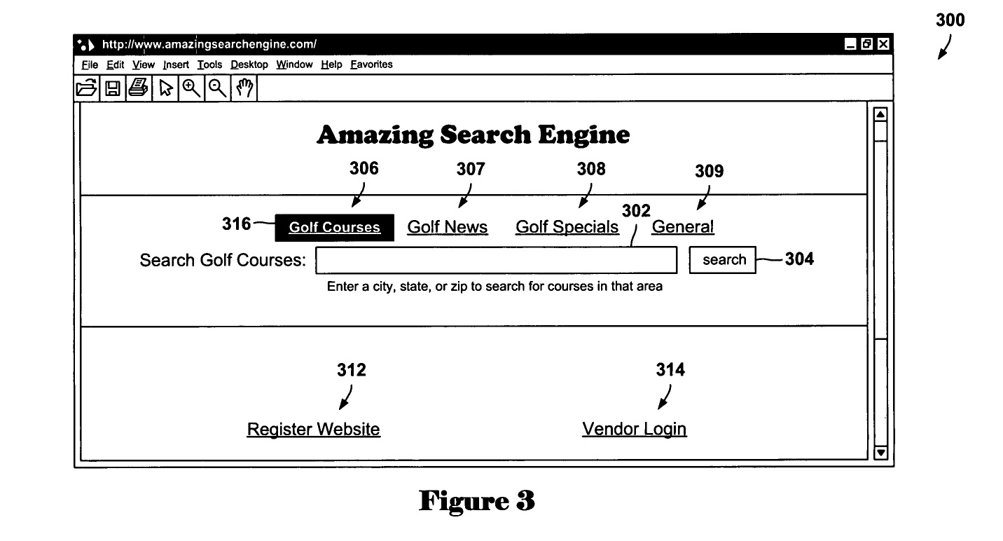

FIG. 3 shows an exemplary home page for an e-commerce search engine that represents one embodiment of the present invention. Home page 300 includes a search input window 302 for input of key-word searches, a SEARCH button 304 to initiate searches, and four search categories: golf courses 306, golf news 307, golf specials 308, and a general category 309. Home page 300 also includes a website link 312 to a vendor-registration page where a business can register a website, and a website link 314 to a vendor-login page where an already-registered vendor can login to add, manage, and remove retail items listed for sale via the e-commerce search engine.

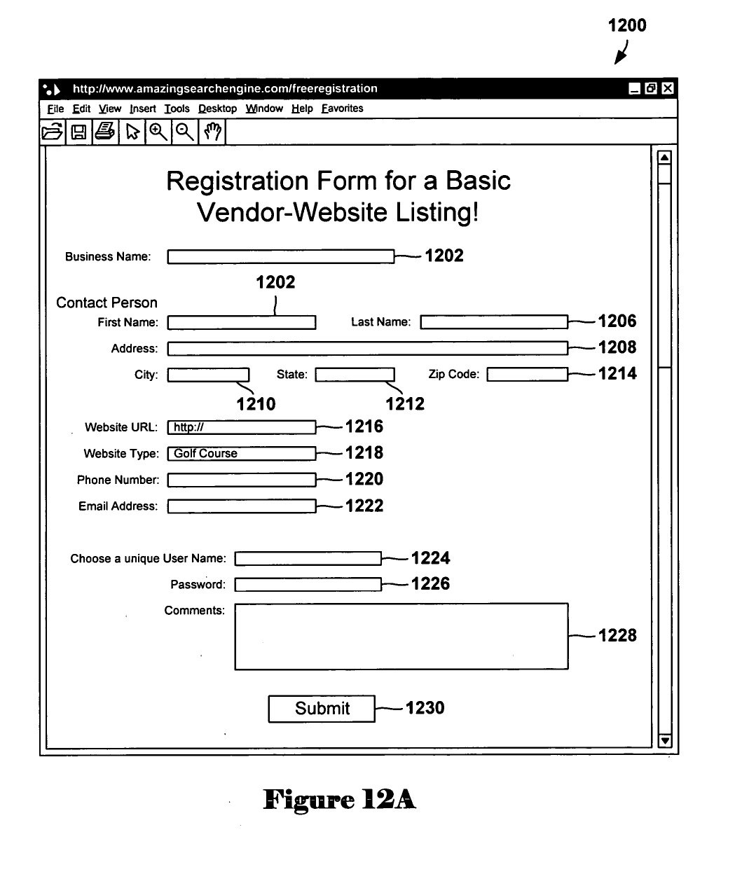

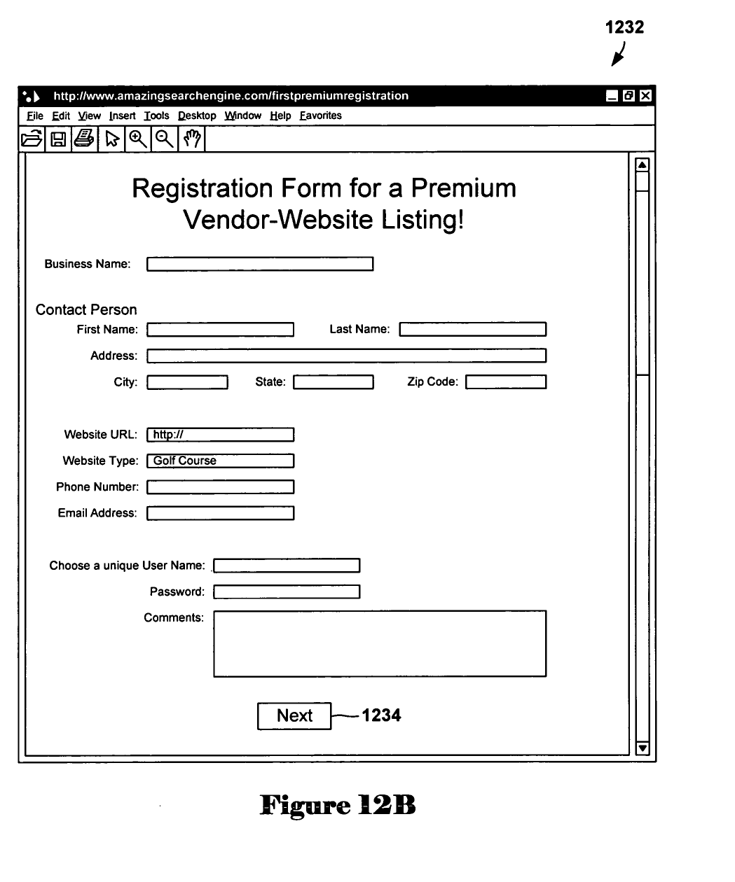

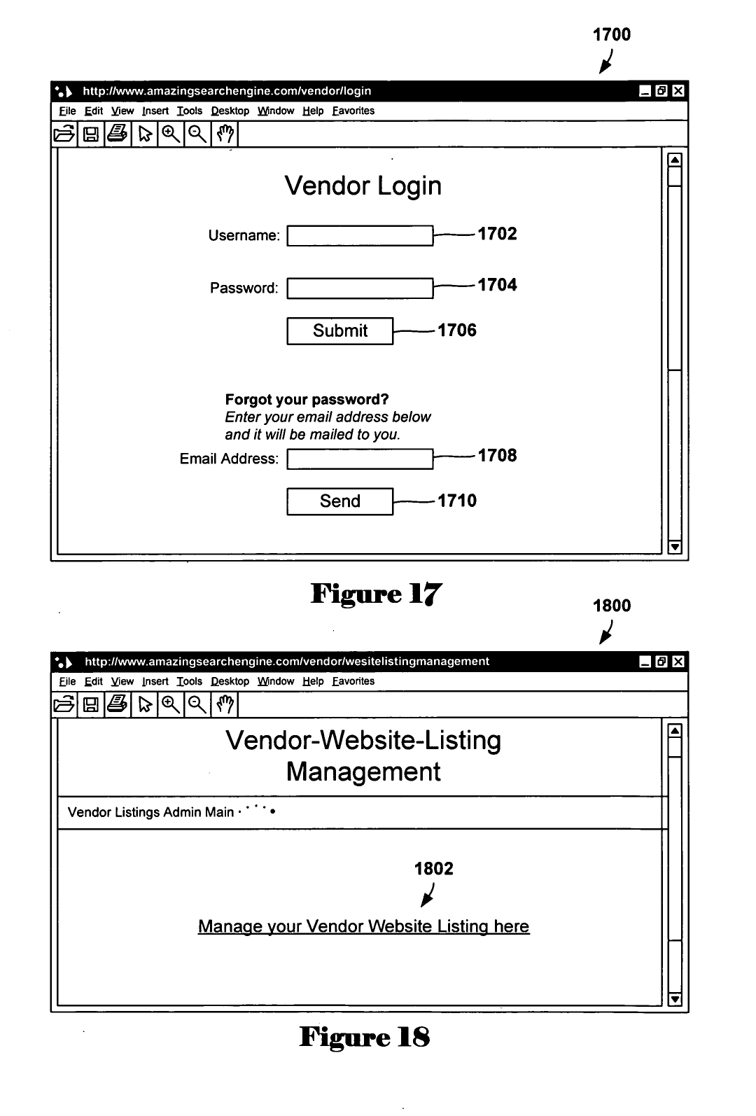

A user can narrow a search by choosing one of the categories 306-309. In FIG. 3, a user's search has been narrowed to golf courses, as indicated by filled box 316. A user can search for a golf course by inputting geographic key words into search input window 302 to further limit golf-course search results. Geographic key words may include countries, states, regions, cities, and zip codes. Website links 312 and 314 are discussed in detail below, with reference to FIGS. 12B and FIG. 17, respectively.

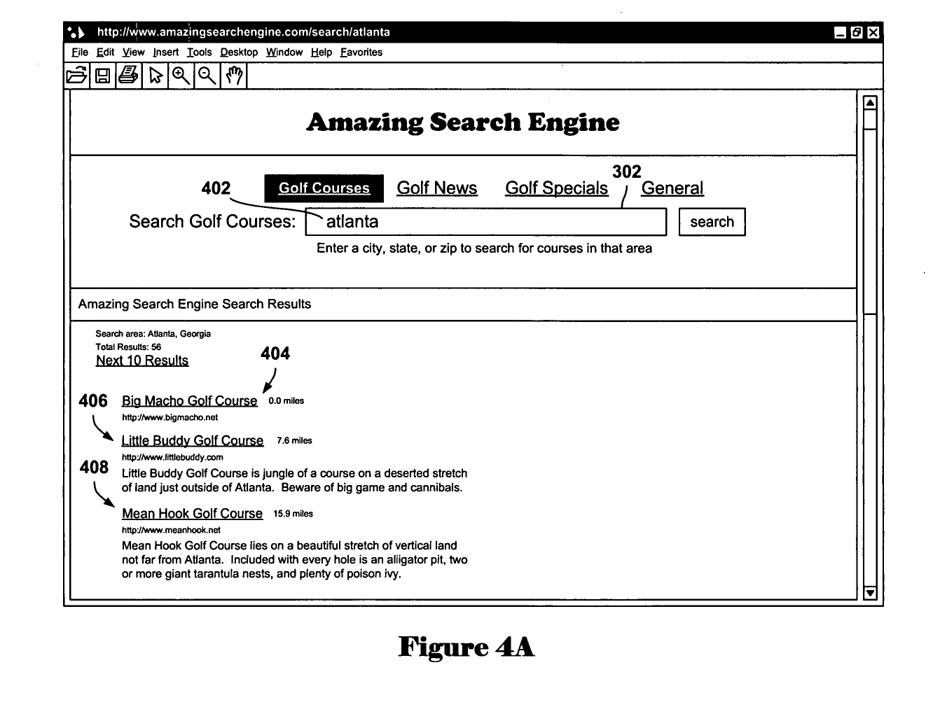

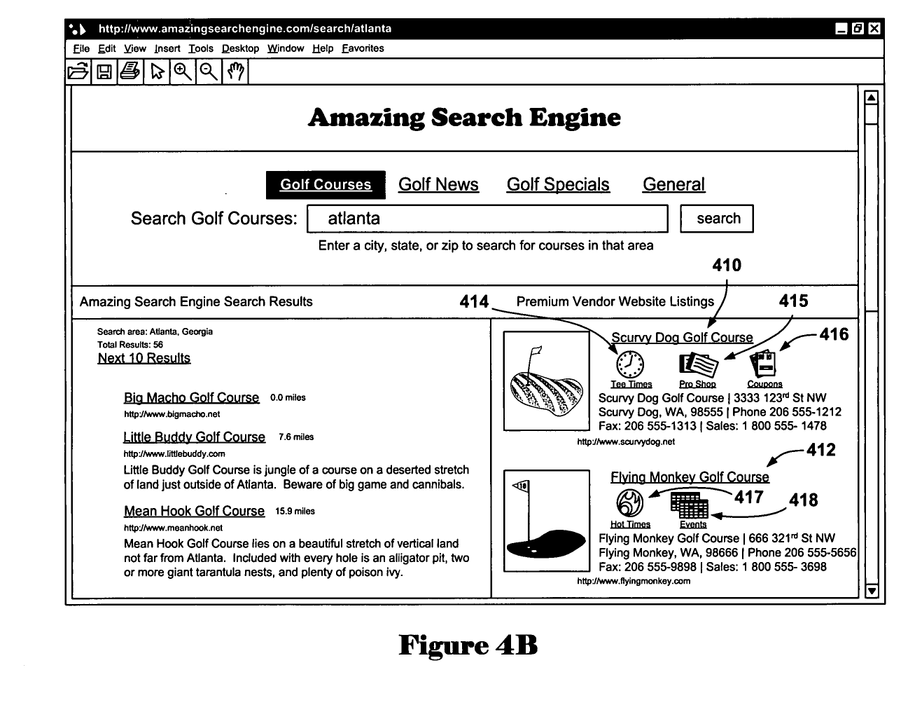

FIG. 4A shows an exemplary home page for an e-commerce search engine that displays search results for a query that represents one embodiment of the present invention. The key word “atlanta” 402 has been entered into search input window 302. The e-commerce search engine has returned annotated website links to fifty-six websites for golf courses located in the vicinity of Atlanta, Ga. FIG. 4A shows the first three website links, Big Macho Golf Course 404, Little Buddy Golf Course 406, and Mean Hook Golf Course 408. The website links shown in FIG. 4A are for basic vendors and are listed in order of descending geographical proximity to Atlanta, Ga. Big Macho Golf Course 404 is listed first at 0.0 miles from Atlanta, Ga., Little Buddy Golf Course 406 is listed second at 7.6 miles from Atlanta, Ga., and Mean Hook Golf Course 408 is listed third at 15.9 miles from Atlanta, Ga.

When a user clicks on any of the website links to the three golf courses 404, 406, and 408, the corresponding golf-course website is displayed. Once the website of the individual golf course is displayed, the user can browse the golf-course website looking for retail items. However, retail items purchased within the golf-course website are not purchased via the e-commerce search engine.

In one embodiment of the present invention, a golf course, or other golf-related business that registers as a premium vendor on the e-commerce search engine has a premium vendor-website listing that is distinctly positioned in relation to basic vendor-website listings such as the basic vendor-website listings shown in FIG. 4A. Premium vendors also can have quick links included in a premium vendor-website listing. Users can click on quick links to purchase retail items from a vendor via the e-commerce search engine. FIG. 4B shows an exemplary home page for an e-commerce search engine that includes search results for golf courses with quick links and that represents one embodiment of the present invention. In addition to the three golf courses displayed and discussed with reference to FIG. 4A, two additional golf courses are shown in FIG. 4B, Scurvy Dog Golf Course 410 and Flying Monkey Golf Course 412. Scurvy Dog Golf Course 410 and Flying Monkey Golf Course 412 are both premium vendors with premium vendor-website listings containing quick links that, when clicked, provide quick access to a specific type of retail item without re-direction to the premium vendor's website. Each particular icon is used to represent a particular type of retail item for sale from the corresponding premium vendor. Scurvy Dog Golf Course 410 contains three quick links: tee times 414, pro shop 415, and coupons 416; and Flying Monkey Golf Course 412 contains two quick links: hot times 417 and events 418.

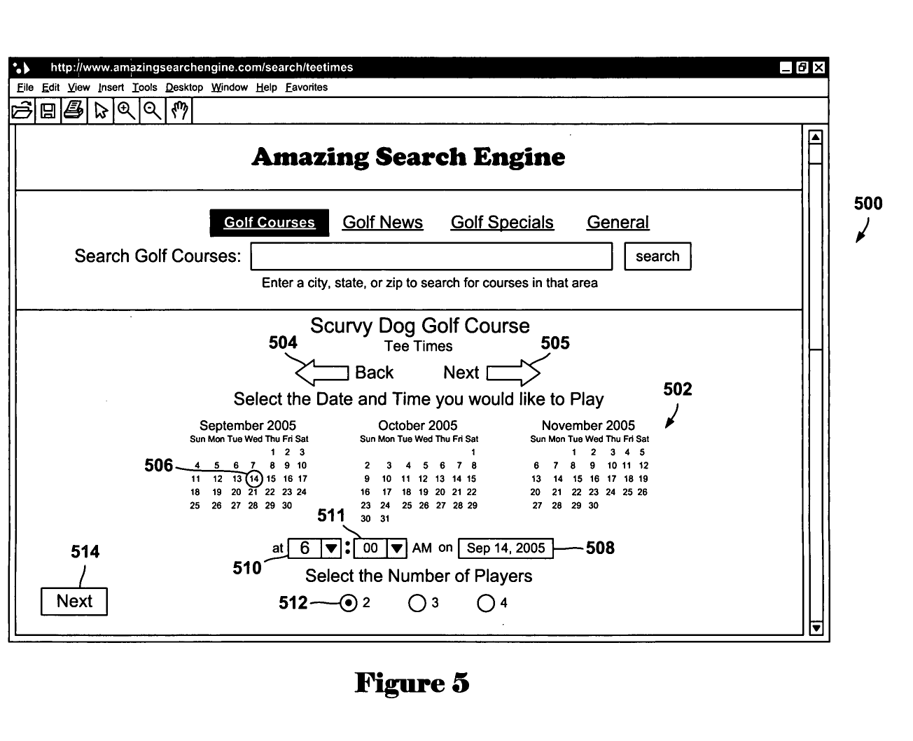

FIG. 5 and FIGS. 7-10 show five exemplary pages, or shops, displayed when a user clicks on each of the five quick links shown in FIG. 4B. When a user clicks on the tee-times quick link 414 in FIG. 4B, a tee-times page is displayed. FIG. 5 shows an exemplary tee-times page, accessed via a quick link included in a vendor-website listing displayed as a search result by an e-commerce search engine that represents one embodiment of the present invention. Tee-times page 500 provides a way for a user to purchase a specific tee time for Scurvy Dog Golf Course 410 in FIG. 4B. Tee-times page 500 includes a graphical depiction of a three-month period of time 502. Arrows 504 and 505 allow a user to select a particular three-month period for display on tee-times page 500. A user can select a specific date on one of the three displayed months by moving circle 506 to the desired date for playing a round of golf. The selected date is shown on display 508. The specific time of day for a tee time on the selected day can be selected via hour input window 510 and minute input window 511. The number of players teeing off at the selected day and time can be selected by clicking one of the player-number choices, such as player-number choice 512. When the user is finished selecting the desired information, the user can click the NEXT button 514, which displays a transaction page.

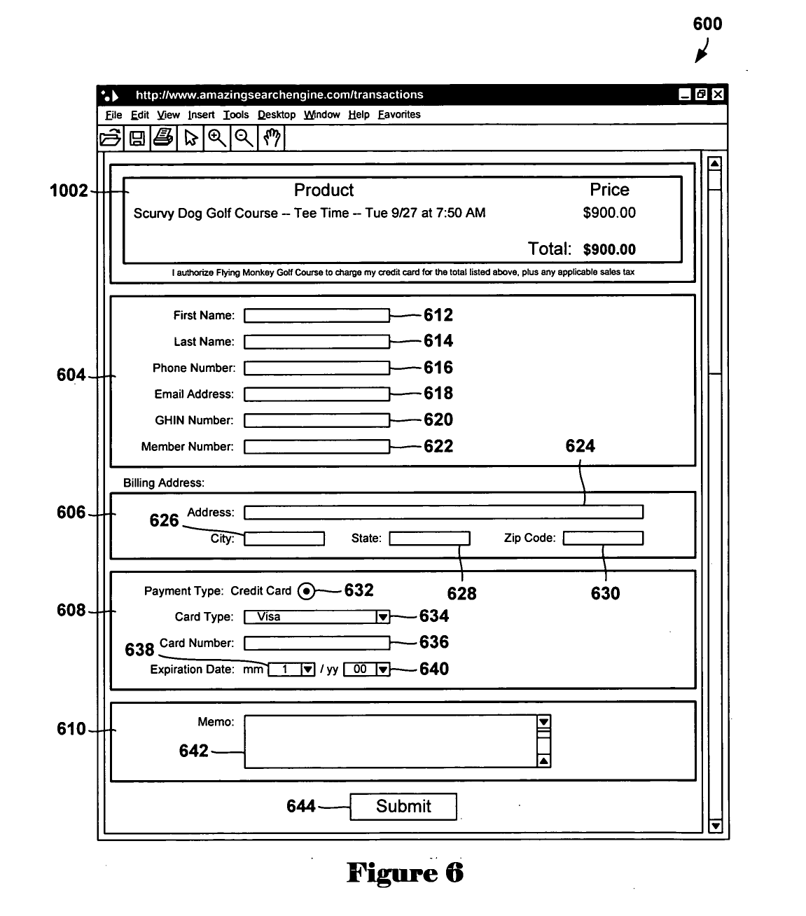

The transaction page shows the selected information input to the tee-times page 500, along with additional information for the user to input to place the order. FIG. 6 shows an exemplary transaction page, displayed subsequent to the selection of a retail item for purchase, by an e-commerce search engine that represents one embodiment of the present invention. Transaction page 600 includes five panels: a purchased-items-and-prices panel 602, a personal-information panel 604, a billing-address panel 606, a payment-method panel 608, and a miscellaneous-memo panel 610.

Purchased-items-and-prices panel 602 includes retail items selected in one of the retail-item shops shown in FIG. 5 and FIGS. 7-10. In FIG. 6, information from the purchase of a tee time at Scurvy Dog Golf Course is shown. A user can click on a number of input windows in the remaining four panels to fill out applicable information related to the purchase of the items shown in the purchased-items-and-prices panel 602.

Personal-information panel 604 includes: a purchasing user's first name input window 612, last name input window 614, phone-number input window 616, email-address input window 618, golf-handicap-and-information-network-number input window 620, and golf-club-membership-number input window 622. Billing-address panel contains input windows for inputting a purchasing user's billing address, including a street-address input window 624, a city input window 626, a state input window 628, and a zip-code input window 630. Payment-method panel contains credit-card-information input windows, including a credit-card-payment indicator 632 and input windows for inputting credit card type 634, credit card number 636, and the month 1038 and year 640 of the expiration of the purchasing credit card. Miscellaneous-memo panel 610 contains input window 642 that allows a user to type out a message that is passed to the vendor, along with the transaction information.

When a user is finished inputting purchasing information into the appropriate input windows in transaction page 600, the user can click on a SUBMIT button 644 to send the information to the vendor-control menu of the e-commerce search engine. Once the information arrives at the vendor-control menu, the selling vendor is notified of the transaction and the information remains idle until the vendor accesses the information to complete the order. The user subsequently receives confirmation of the placement and the shipping of the order. The confirmation can be supplied via an email message transmitted to the email address provided by the user in input window 618 of FIG. 6. However, confirmation can be made in any number of different ways, such as by phone using the user-provided phone number in input window 616 of FIG. 6, or by mail using the user-provided shipping address input to the input windows contained in billing-address panel 606 of FIG. 6.

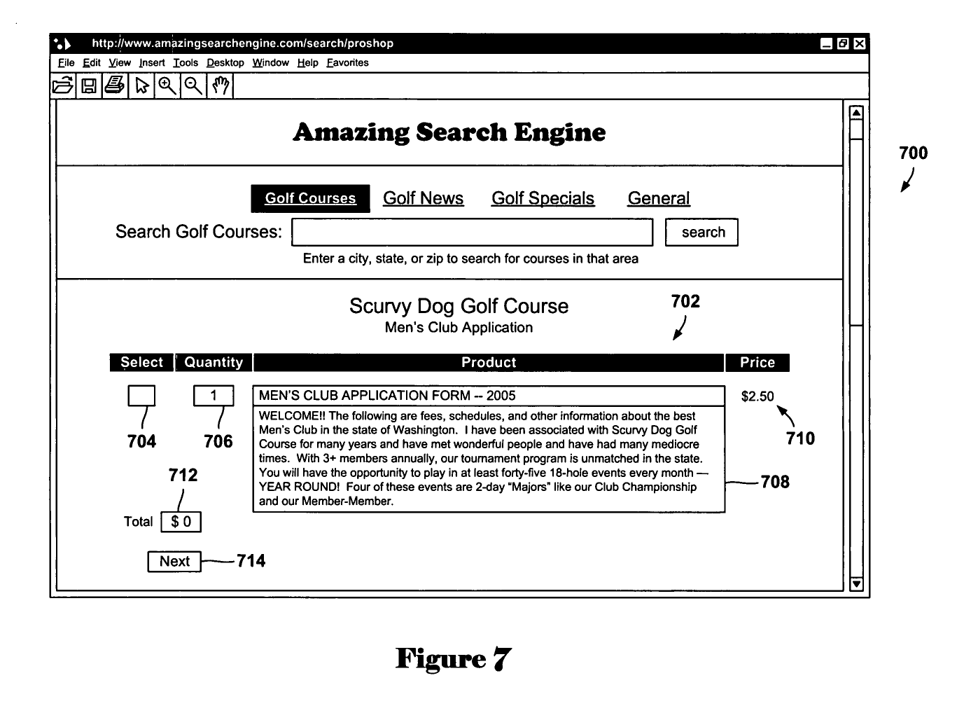

When a user clicks on the pro shop quick link 415 in FIG. 4B, a pro-shop page is displayed to the user. FIG. 7 shows an exemplary pro-shop page, accessed via a quick link included in a vendor-website listing displayed as a search result by an e-commerce search engine that represents one embodiment of the present invention. Pro-shop page 700 includes a retail-item listing 702 for a men's club application form for Scurvy Dog Golf Course 412 in FIG. 4B. The retail-item listing 702 includes a selection box 704 that can be clicked to select purchase of the retail item listed, a quantity box 706 to select the number of retail items desired, a product-description box 708 that provides a name and a description of the retail item, and a price 710. Total-price display 712 totals the price for the retail items selected by a user. Only a single item is shown in FIG. 7, however, many retail items may be listed on the pro-shop page 700. Moreover, many different types of retail items can be listed for sale besides golf club memberships, including golf clubs, golf balls, shirts, golf shoes, golf pants, how-to videos, golf lessons, and other golf-related merchandise. When the user is finished selecting retail items to purchase, the user can click the NEXT button 714, which displays a transaction page.

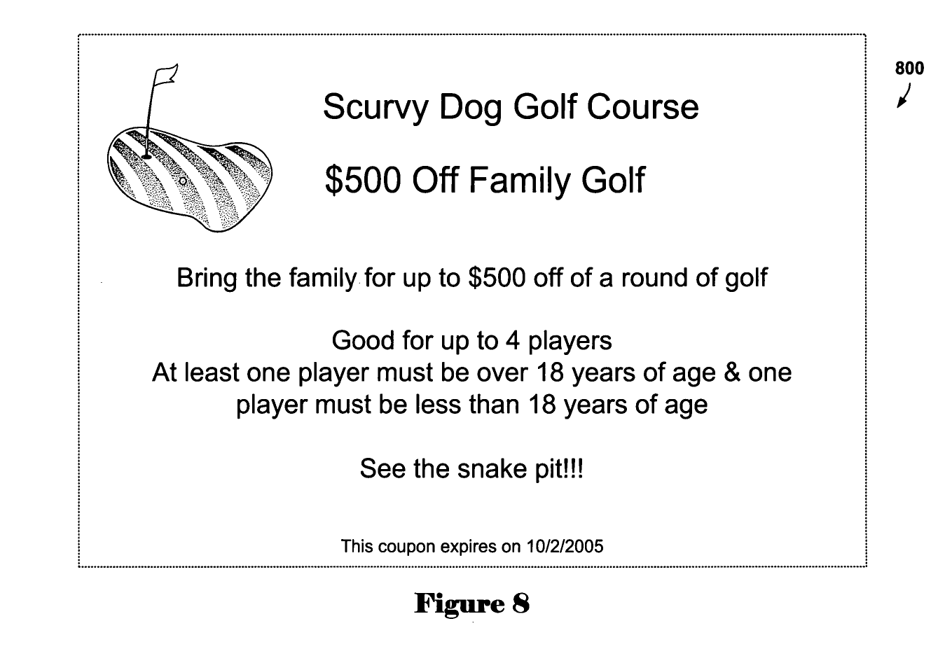

When a user clicks on the coupons quick link 416 in FIG. 4B, a coupon page is displayed. FIG. 8 shows an exemplary coupons page, accessed via a quick link included in a vendor-website listing displayed as a search result by an e-commerce search engine that represents one embodiment of the present invention. Coupon 800 gives the bearer a discount for $500 off of a round of family golf at Scurvy Dog Golf Course 412 in FIG. 4B. Coupon 800 can be printed out by a user and redeemed at Scurvy Dog Golf Course 412 in FIG. 4B, subject to the terms listed on the coupon 800.

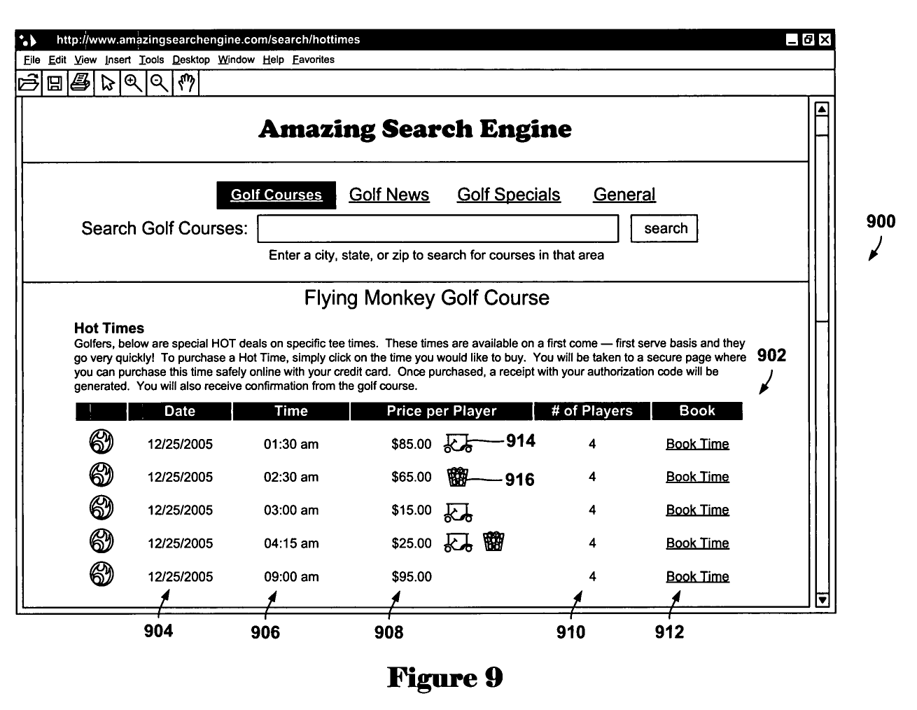

When a user clicks on the hot-times quick link 417 in FIG. 4B, a hot-times page is displayed. A hot time is a listing for a reduced-rate tee time. FIG. 9 shows an exemplary hot-times page, accessed via a quick link included in a vendor-website listing displayed as a search result by an e-commerce search engine that represents one embodiment of the present invention. Hot-Times page 900 includes a set of hot-times listings 902. Each hot-times listing 902 contains a date, such as date 904, a time of day, such as time of day 906, a price per player, such as price per player 908, a number of players able to be added to the tee time, such as number of players 910, and a book-time link, such as book-time link 912, which displays the transaction page. A user can click on the book-time link 912 to select the hot time with the desired date, time, price per player, and number of players. Additionally, golf-cart icons, such as golf-cart icon 914, indicate that the price per player includes a golf cart. Bucket-of-balls icons, such as bucket-of-balls icon 916, indicate that a bucket of range balls is included in the price per player.

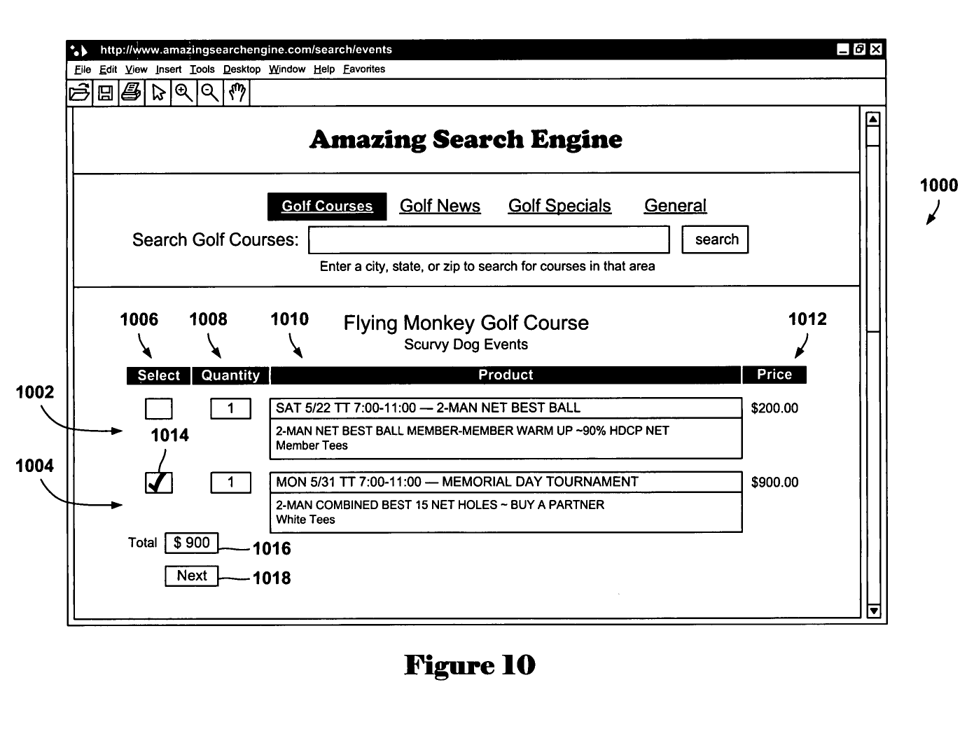

When a user clicks on the events quick link 418 in FIG. 4B, an events page is displayed. FIG. 10 shows an exemplary events page, accessed via a quick link included in a vendor-website listing displayed as a search result by an e-commerce search engine that represents one embodiment of the present invention. Events page 1000 shows two listings for upcoming-event registrations at Flying Monkey Golf Course 412 in FIG. 4B: a two-man net-best-ball event 1002, and a Memorial Day Tournament 1004. Each listed event includes a selection box 1006 that can be clicked to select the purchase of the particular event listing, a quantity box 1008 where a user can select the number of event passes desired, a product-description box 1010 where the event is named and described, and a price 1012 for the listed event. Selected events can be shown differently that unselected events in the selection box 1006. For example, the Memorial Day Tournament 1004 is shown with a checkmark 1014 in the associated selection box 1006, indicating that the Memorial Day Tournament 1004 has been selected by a user. Total-price display 1016 displays the total price for selected events. FIG. 10 shows one selected event with a price of $900. Accordingly, the total-price display 1016 shows a total price of $900. Only two different events are shown in FIG. 10, however, many different events may have an event listing in the events page 1000, including parties, charity events, auctions, festivals, special events at a golf-course restaurant or bar, and other golf-related events. When the user is finished selecting event passes, the user can click the NEXT button 1018, which displays a transaction page.

### The Vendor's Perspective

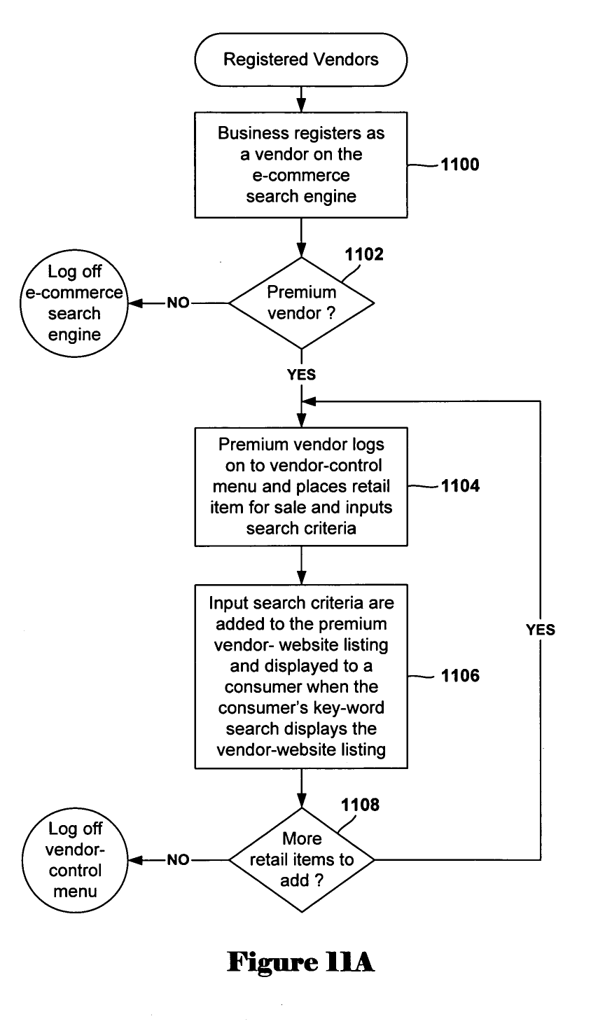

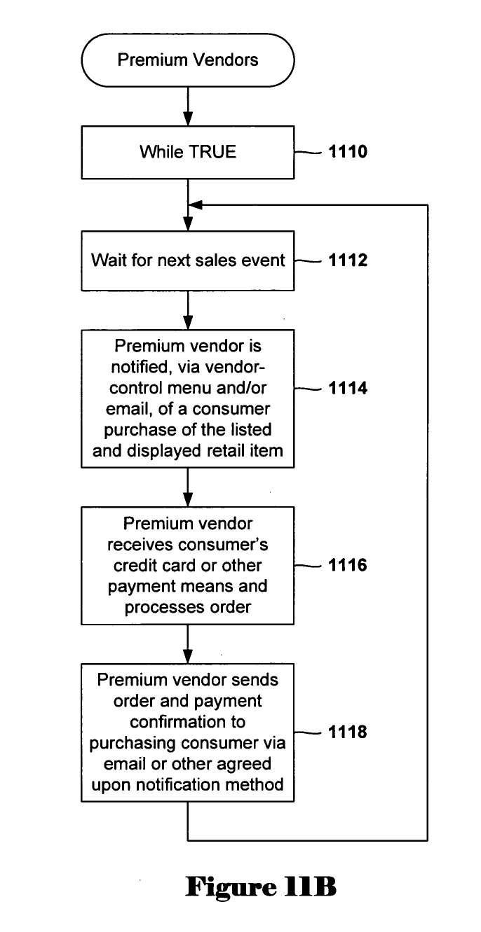

A business engaged in e-commerce can register as either a basic vendor or a premium vendor on the e-commerce search engine. FIG. 11A shows a control-flow diagram of exemplary actions taken by a business registering as a vendor to sell retail items via an e-commerce search engine that represents one embodiment of the present invention. In step 1100, a business engaged in e-commerce registers as a premium vendor or a basic vendor on an e-commerce search engine. If a business registers as a premium vendor in step 1102, control is passed to step 1104, otherwise the business can log off the e-commerce search engine. In step 1104, a business that registers as a premium vendor accesses a vendor-control menu where the premium vendor can add a retail item destined for sale over the e-commerce search engine. Once the retail item is added, the retail item can be managed or removed. The vendor-control menu can also be used to set up search criteria for directing user searches to a premium vendor-website listing, and also provide billing information to the e-commerce search engine for maintaining the premium vendor-website listing. In step 1106, information placed on the vendor-control menu is added to the premium vendor's existing premium vendor-website listing. The new information is displayed, along with the already-displayed information, whenever the information contained in the premium vendor-website listing is considered by the e-commerce search engine to be relevant to a user's search query. In step 1108, when the premium vendor desires to place additional items for sale over the e-commerce search engine, control is passed to step 1104. Otherwise, the premium vendor logs off the vendor-control menu.

FIG. 11B shows a control-flow diagram of exemplary actions taken by a premium vendor during a sales event via an e-commerce search engine that represents one embodiment of the present invention. In step 1110, while a premium vendor maintains premium-vendor status, steps 1112 through 1118 can be repeated infinitely. In step 1112, the premium vendor waits for a user to purchase a retail item from the premium vendor. In step 1114, the premium vendor is notified of a purchase of a retail item displayed on the premium vendor-website listing. The notification may come in any number of different ways, including via email, or via a prompt to the premium vendor when the premium vendor is logged onto the vendor-control menu. In step 1116, the premium vendor is sent transactional information regarding the user purchase, as described above with reference to FIG. 6. The transactional information can be accessed by the premium vendor through the vendor-control menu. Alternately, the transactional information can be sent to other mutually-agreed-upon locations, such as a direct deposit with the premium vendor's bank. In step 1118, the premium vendor sends an order confirmation to the user and ships the order to the requested shipping address. The order confirmation may be sent via any number of mutually-agreed-upon methods, including via email, via telephone, or via mail.

When a vendor registers as a basic vendor, the basic vendor has a basic vendor-website listing that is displayed when applicable key-word searches are provided by users browsing for retail items, as shown above with reference to FIG. 4A. Basic vendor-website listings are arranged in order of descending geographical distance from a given location when a geographical key-word search is performed by a user. Basic vendor-website listings do not have quick links within the basic vendor-website listing, and transactions with users are done directly through the basic vendor website.

FIG. 12A shows an exemplary on-line registration page for a basic vendor-website listing displayed by an e-commerce search engine that represents one embodiment of the present invention. Basic-registration page 1200 includes the input windows: business name 1202, a contact person's first name 1204 and last name 1206, address 1208, city 1210, state 1212, and zip code 1214, a website address 1216, a website business type 1218, a phone number 1220, an email address 1222, a unique user name 1224 and password 1226, and any additional comments 1228. Once appropriate information is input to each of the provided input windows on the basic-registration page 1200, the basic vendor can click the SUBMIT button 1230 to submit the information to the e-commerce search engine for processing.

Once the registration information is submitted, representatives of the e-commerce search engine evaluate the registration and, if the registration is accepted, an email is sent to verify the email address listed in input window 1222 in FIG. 12A. The basic vendor can then click on a link provided in the email message to confirm the email address. The basic vendor-website listing is then complete and the basic vendor-website listing is displayed when a user performs a key-word search with key-words relevant to the basic vendor-website listing. For example, by business name, as listed in input window 1202, or by geographical region, as listed in input windows 1208, 1210, 1212, and 1214.

FIGS. 12B-16 describe a five-part registration process for registering a premium vendor-website listing. FIG. 12B shows the first page of an exemplary on-line registration process for a premium vendor-website listing displayed by an e-commerce search engine that represents one embodiment of the present invention. Premium first-part registration page 1232 includes similar input windows to the basic registration page shown in FIG. 12A. After inputting the information requested by premium first-part registration page 1232, the premium vendor can click the NEXT button 1234 to display the second registration page.

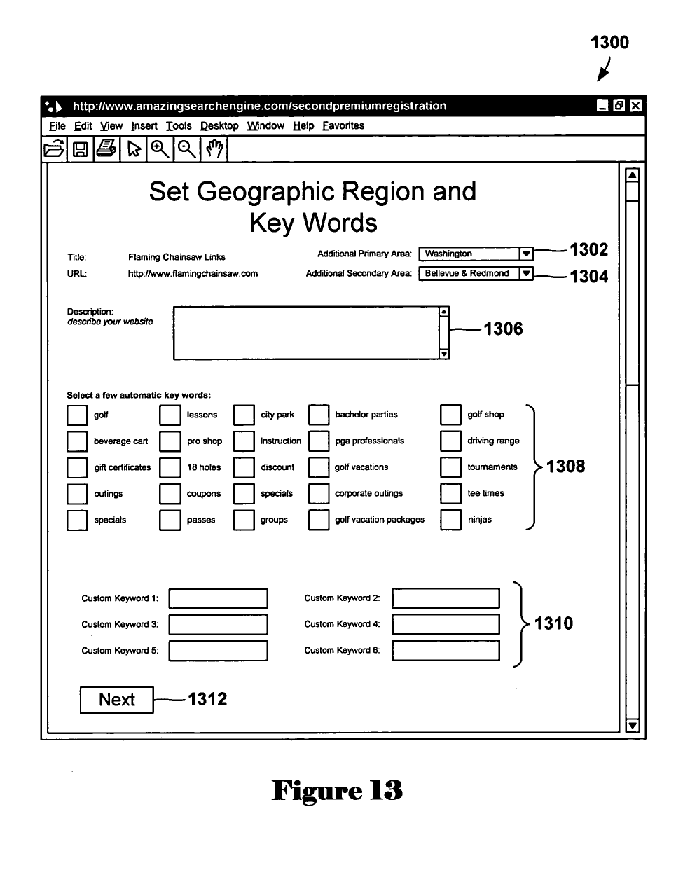

FIG. 13 shows the second page of an exemplary on-line registration process for a premium vendor-website listing displayed by an e-commerce search engine that represents one embodiment of the present invention. Premium second-part registration page 1300 provides a place for a premium vendor to input information to establish a geographic region and key words to help a browsing user accurately reach the premium vendor-website listing. Premium second-part registration page 1300 includes additional primary geographic input window 1302, additional secondary geographic input window 1304, website-description input window 1306, automatic key words 1308, custom key words 1310, and NEXT button 1312.

A vendor-website listing is automatically indexed in a geographical region by zip code as input to the zip code input window shown in FIG. 12A-12B. However, a premium vendor may select an additional geographic area that can be used to display a premium vendor-website listing. Additional primary geographic input window 1302 can be used to input an additional state which provides another geographical key-word that displays the premium vendor-website listing when used in a key-word search by a user. Additional secondary geographic input window 1304 narrows the additional primary geographic input window 1302 into smaller regions. Website-description input window 1306 allows a premium vendor to write a description of the business used in the premium vendor-website listing. A premium vendor can select a few commonly-used, golf-related, automatic key words 1308 to help identify the types of retail items that will be contained on the premium vendor-website listing. A few custom key words 1310 can also be used by the premium vendor to more accurately identify the types of retail items contained on the vendor-website listing. When the premium vendor has completed filling out the applicable information, the premium vendor can click on the NEXT button 1312 to display the third registration page.

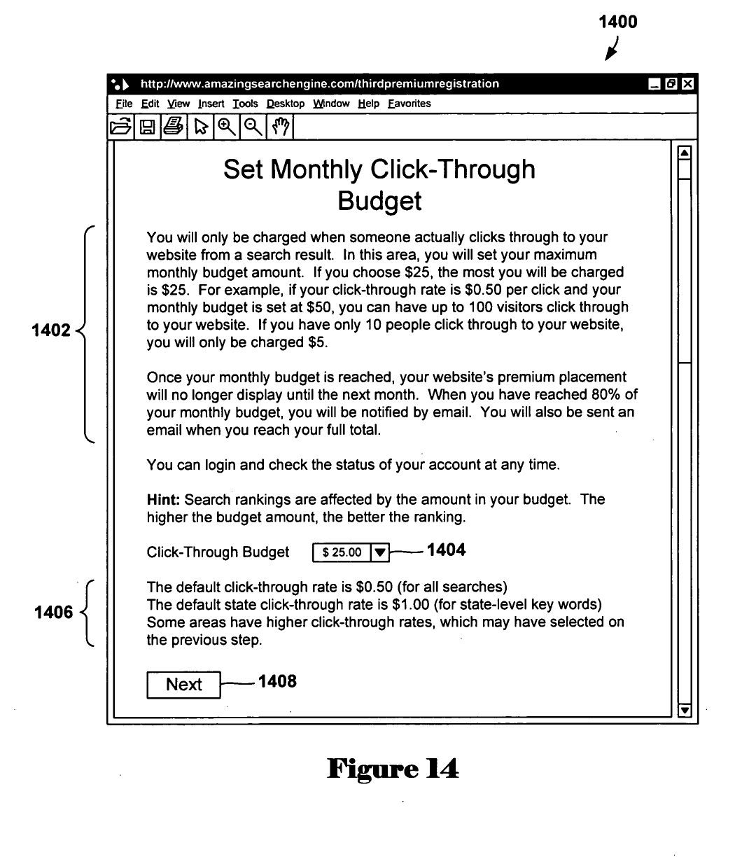

FIG. 14 shows the third page of an exemplary on-line registration process for a premium vendor-website listing displayed by an e-commerce search engine that represents one embodiment of the present invention. Premium third-part registration page 1400 includes an explanation 1402 for how a premium vendor will be charged, based on the number of times a user “clicks through” a premium vendor-website listing. Premium third-part registration page 1400 also includes a click-through budget input window 1404 where a premium vendor can select the amount of money he or she is willing to spend per month on click-through fees, an explanation 1406 of how much a premium vendor will be charged for a click-through, and a NEXT button 1408 to click and display the fourth registration page.

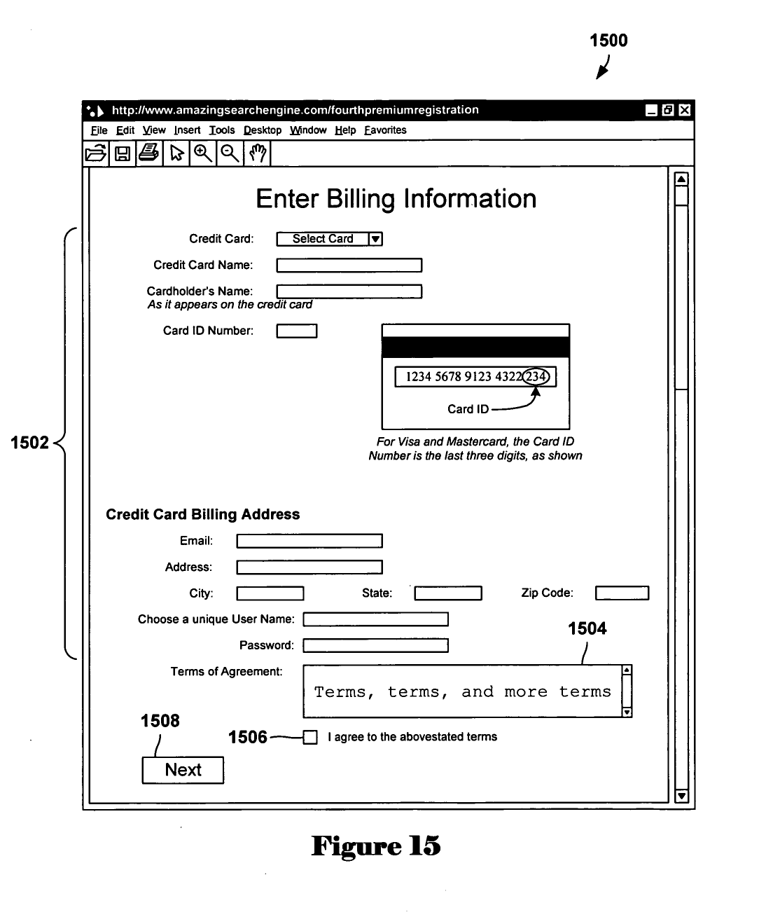

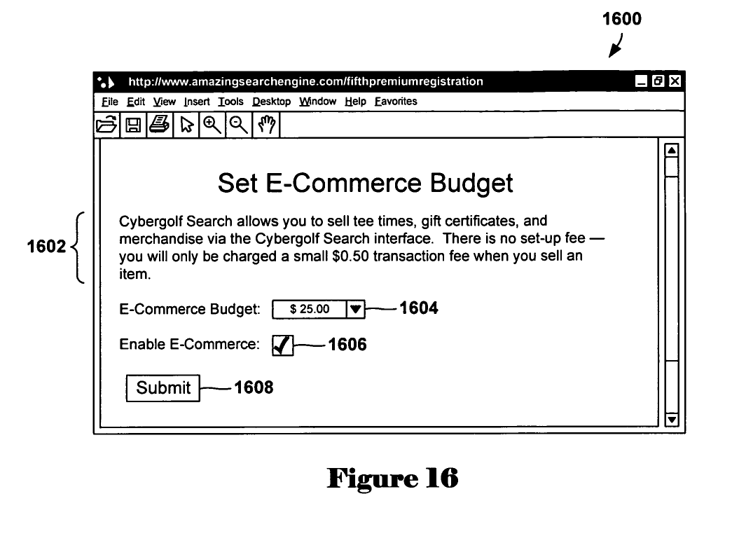

FIG. 15 shows the fourth page of an exemplary on-line registration process for a premium vendor-website listing displayed by an e-commerce search engine that represents one embodiment of the present invention. Premium fourth-part registration page 1500 includes eleven input windows 1502 where information can be input to establish billing information for a premium vendor to pay the e-commerce search engine for fees, such as click-through fees and transaction fees (discussed below with reference to FIG. 16). FIG. 15 also includes an input window 1504 showing the terms of the agreement between a premium vendor and the e-commerce search engine, a box 1506 to click if the premium vendor agrees to the terms listed in input window 1504, and a NEXT button 1508 to click to display the fifth registration page.

FIG. 16 shows the fifth page of an exemplary on-line registration process for a premium vendor-website listing displayed by an e-commerce search engine that represents one embodiment of the present invention. Premium fifth-part registration page 1600 includes an explanation 1602 of how much a premium vendor will be charged for a transaction fee whenever a user purchases a retail item via the e-commerce search engine, an e-commerce budget input window 1604 where a premium vendor can input the amount of money that his or her business is willing to pay in transaction fees per month, an e-commerce-enablement button 1606 that activates the e-commerce ability of the premium vendor-website listing, and a SUBMIT button 1608 to click when the premium vendor has completed inputting the information requested in the five pages of the premium vendor-website listing registration.

Once the registration process is complete, a premium vendor may desire to start adding retail items to the newly-created premium vendor-website listing. Retail items can be added, removed and managed via a vendor-control menu. FIG. 17 shows an exemplary vendor-login page that a premium vendor can use to access a vendor-control menu displayed by an e-commerce search engine that represents one embodiment of the present invention. Vendor-login page 1700 includes a username input window 1702, a password input window 1704, a SUBMIT button 1706, an email-address input window 1708, and a SEND button 1710. A premium vendor logs on to the vendor-control menu by inputting a username and a password into input windows 1702 and 1704, respectively. The premium vendor's username and password were previously created by the vendor in the first part of the premium vendor registration process shown in FIG. 12B. In the event that a premium vendor has forgotten his or her password, the premium vendor can input an email address to the email address input window 1708. The e-commerce search engine can send the forgotten information to the email address input to email-address input window 1708, provided that the input email address matches the email address input by the premium vendor in the first part of the premium vendor registration process shown in FIG. 12B.

When a premium vendor completes the login procedure discussed with reference to FIG. 17, a vendor-website-listing management page is displayed that allows a premium vendor to access a vendor-control menu. FIG. 18 shows an exemplary vendor-website-listing management page displayed by an e-commerce search engine that represents one embodiment of the present invention. Vendor-website-listing management page 1800 includes a vendor-control-menu link 1802 which, when clicked, displays a vendor-control menu.

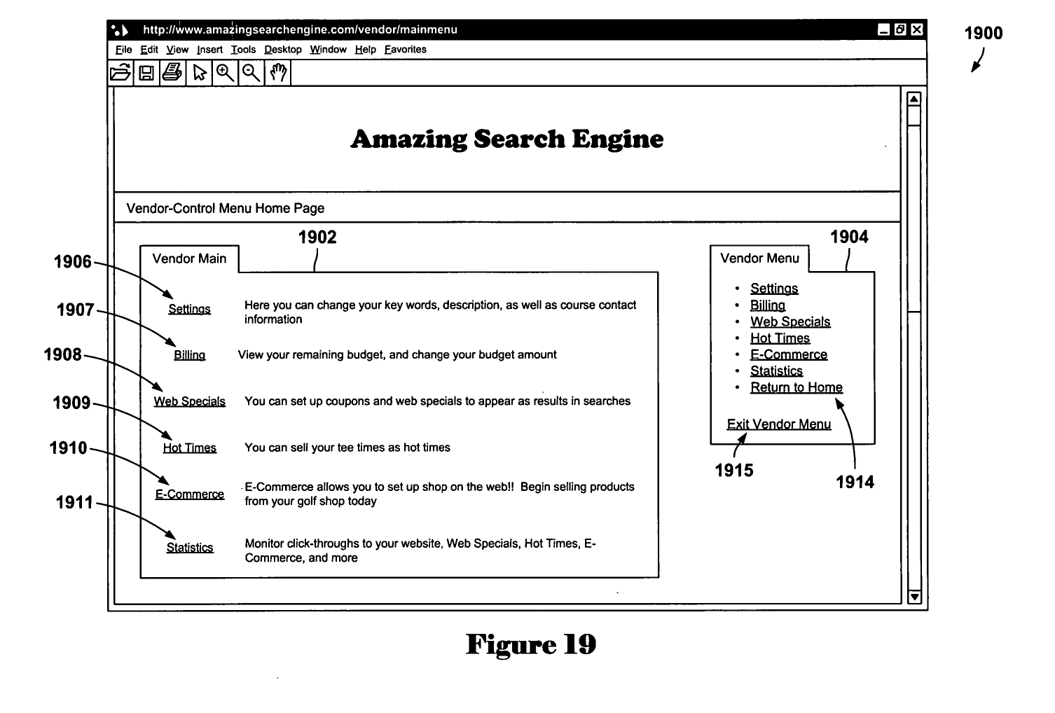

FIG. 19 shows an exemplary vendor-control-menu home page that a premium vendor can use to manage a premium vendor-website listing displayed by an e-commerce search engine that represents one embodiment of the present invention. Vendor-control-menu 1900 includes a vendor main panel 1902 and a vendor menu 1904. Vendor main panel 1902 includes six links 1906-1911 and displays a brief description of what actions a premium vendor can perform. Clicking on the settings link 1906 displays a page where a premium vendor can change key words, retail-item descriptions, and course-contact information. Clicking on the billing link 1907 displays a page where a premium vendor can view and modify the current budget selections. Clicking on the web-specials link 1908 displays a page where a premium vendor can set up coupons and special web offers. Clicking on the hot-times link 1909 displays a page where a premium vendor can add, manage, and remove hot times. Clicking on the e-commerce link 1910 displays a page where a premium vendor can begin adding, managing, and removing retail items offered for sale via the e-commerce search engine. Clicking on the statistics link 1911 displays a page where a premium vendor can monitor click-throughs, sales numbers, and other statistics related to retail items available via the e-commerce search engine. Vendor menu 1904 also includes each of the links 1906-1911 and is included on each of the pages displayed when a premium vendor clicks on any of the links 1906-1911. Vendor menu 1904 also includes a return-to-home link 1914 that, when clicked, displays the vendor-control-menu 1900, and an exit-vendor-menu link 1915 that, when clicked, displays the vendor-website-listing management page 1800 in FIG. 18.

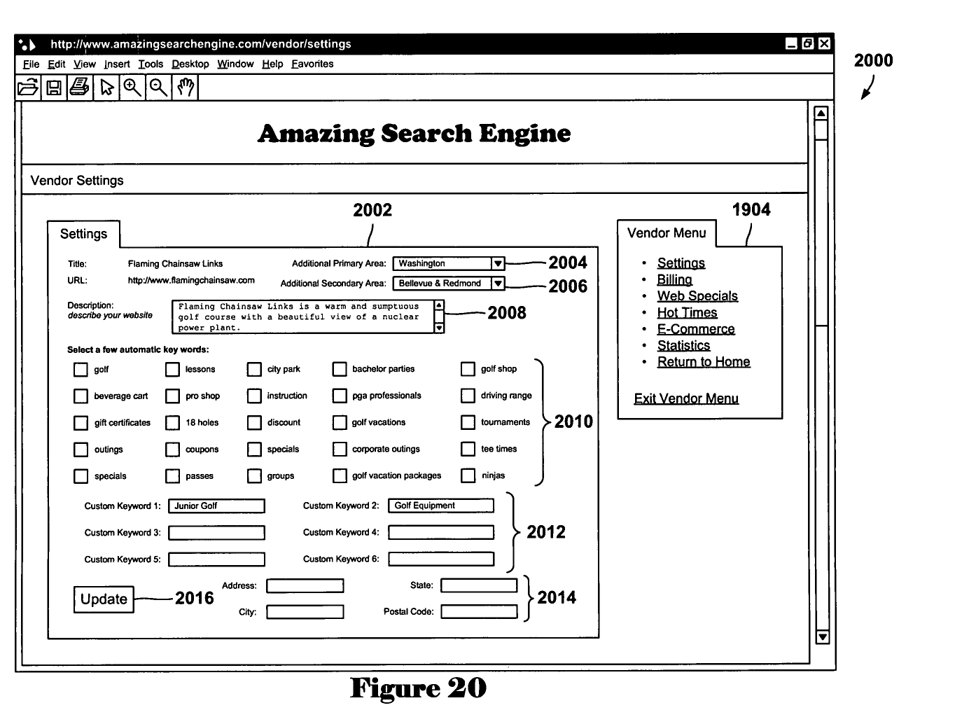

FIGS. 20-24B and FIG. 30 show each of the six pages displayed when one of the six links 1906-1911 in FIG. 19, are clicked by a vendor that is adding, managing, or removing retail items offered for sale via the e-commerce search engine. FIG. 20 shows an exemplary general settings page which a premium vendor can use to change general settings for a premium vendor-website listing displayed by an e-commerce search engine that represents one embodiment of the present invention. General settings page 2000 contains a vendor-settings panel 2002 and a vendor menu 1904. Vendor-settings panel 2002 includes additional primary-geographic input window 2004, additional secondary-geographic input window 2006, website-description input window 2008, automatic key words 2010, custom key words 2012, business-address-information input windows 2014, and UPDATE button 2016. On general settings page 2000, a premium vendor can change any information input during the second part of the premium vendor-website listing registration process, described above with reference to FIG. 13. Additionally, a premium vendor can modify business address information by inputting new information into one or more of business-address-information input windows 2014. When the premium vendor has completed changing the desired information, the premium vendor can click on the UPDATE button 2016 to submit the new information to the e-commerce search engine.

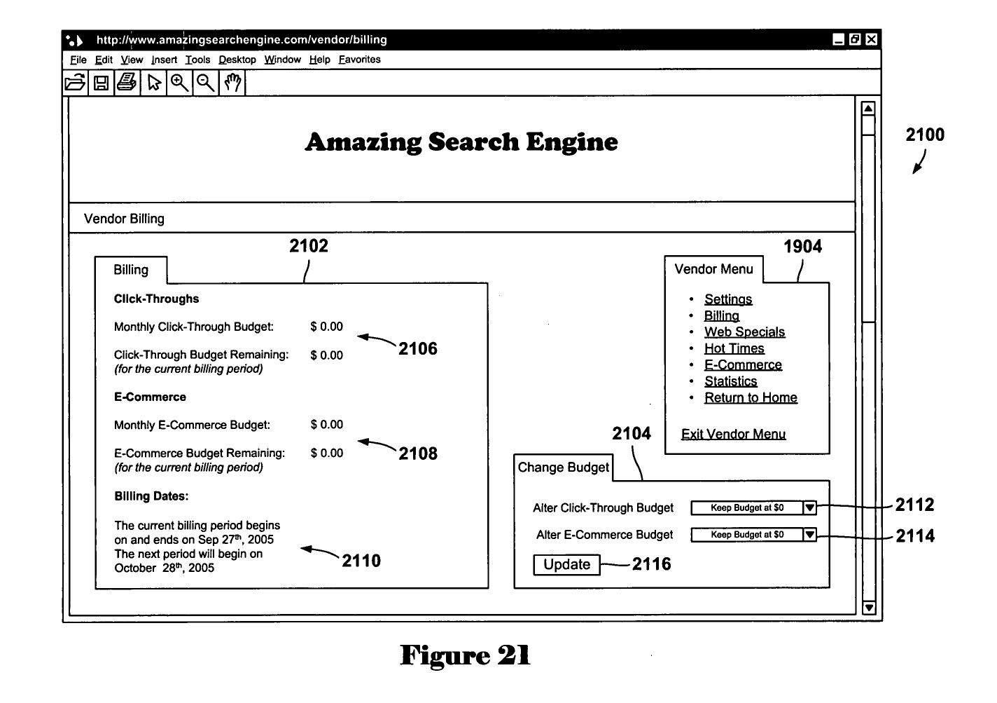

FIG. 21 shows an exemplary billing page that allows a premium vendor to manage budgetary information for a premium vendor-website listing with an e-commerce search engine that represents one embodiment of the present invention. Billing page 2100 contains a billing panel 2102, a budget-changing panel 2104, and a vendor menu 1904. Billing panel 2102 includes a click-through-budget display 2106, an e-commerce-budget display 2108, and a billing-period-dates display 2110. The click-through-budget display shows the current monthly click-through budget, as set in the third part of the premium vendor-website listing registration process, described above with reference to FIG. 14. The click-through-budget display 2106 also shows the amount of money left in the click-through budget for the current billing period, considering an established charge deducted from a balance for every click-through. The e-commerce-budget display 2108 shows the current monthly e-commerce budget, as set in the fifth part of the premium vendor-website listing registration process, described above with reference to FIG. 16. The e-commerce-budget display 2108 also shows the amount of money left in the e-commerce budget for the current billing period, considering an established charge deducted from a balance for every user transaction through the e-commerce search engine. Budget-changing panel 2104 includes a click-through-budget-altering input window 2112 for changing the click-through budget, an e-commerce-budget-altering input window 2114 for changing the e-commerce budget, and an UPDATE button 2116 for submitting an update to either, or both, of input windows 2112 and 2114.

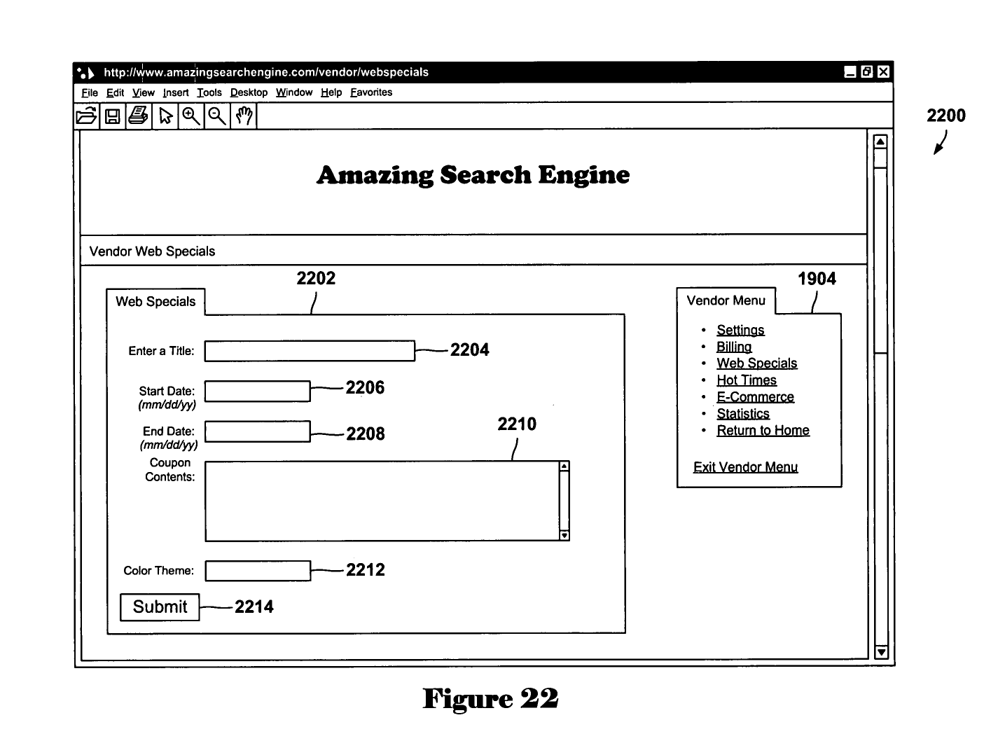

FIG. 22 shows an exemplary web-specials page that allows a premium vendor to manage web specials displayed in association with a premium vendor-website listing by an e-commerce search engine that represents one embodiment of the present invention. Web-specials page 2200 contains a web-specials panel 2202 and a vendor menu 1904. Web-specials panel includes a title input window 2204, a start-date input window 2206, an end-date input window 2208, a coupon-content input window 2210, a color-theme input window 2212, and a SUBMIT button 2214. A premium vendor can place a coupon, such as the coupon shown and described above with reference to FIG. 8, by inputting information into the input windows contained in web-specials panel 2202. Color-theme input window 2212 allows the premium vendor to change the color around the border of the web special when the web special is displayed on the premium vendor-website listing.

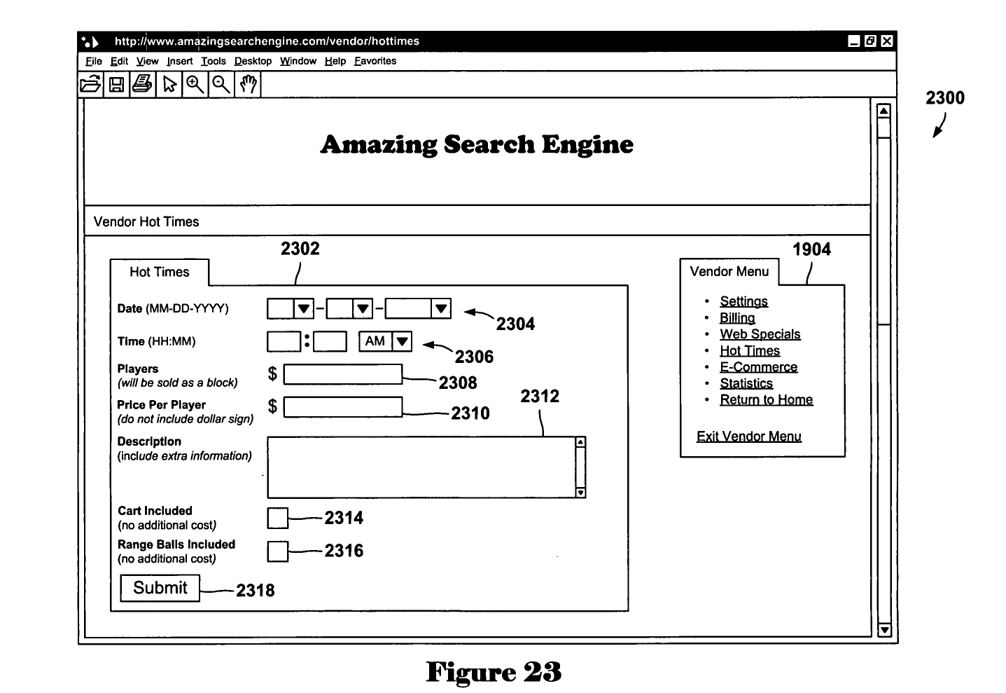

FIG. 23 shows an exemplary hot-times page that allows a premium vendor to manage hot times displayed in association with a premium vendor-website listing by an e-commerce search engine that represents one embodiment of the present invention. Hot-times page 2300 contains a hot-times panel 2302 and a vendor menu 1904. Hot-times panel 2302 includes three date input windows 2304, three time input windows 2306, a number-of-players input window 2308, a price-per-player input window 2310, a description input window 2312, a cart-included indicator 2314, a range-balls-included indicator 2316, and a SUBMIT button 2318. A premium vendor can manage hot times listed on a premium vendor-website listing by inputting information to hot-times panel 2302 to set up hot times listings, such as the hot times displayed on the hot times page, as described above with reference to FIG. 9.

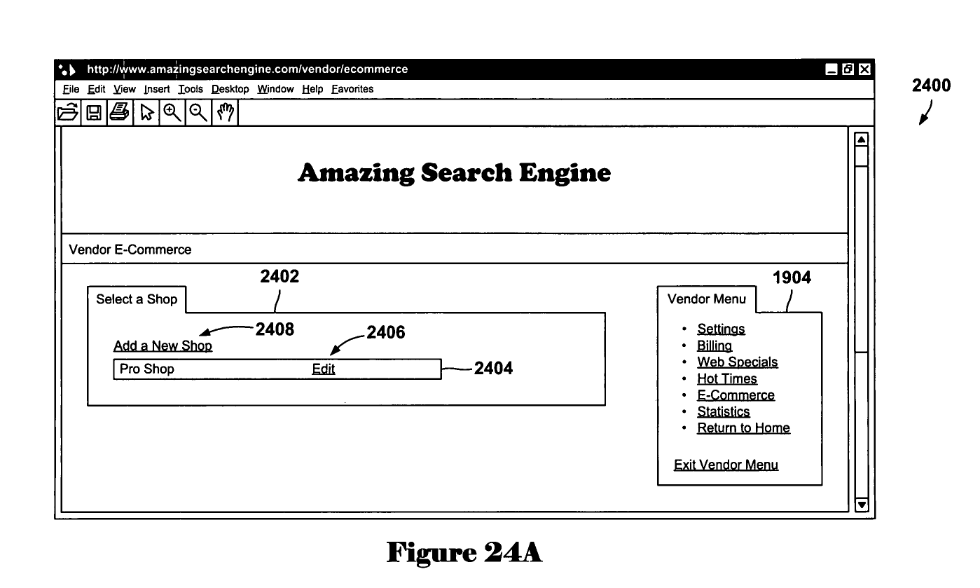

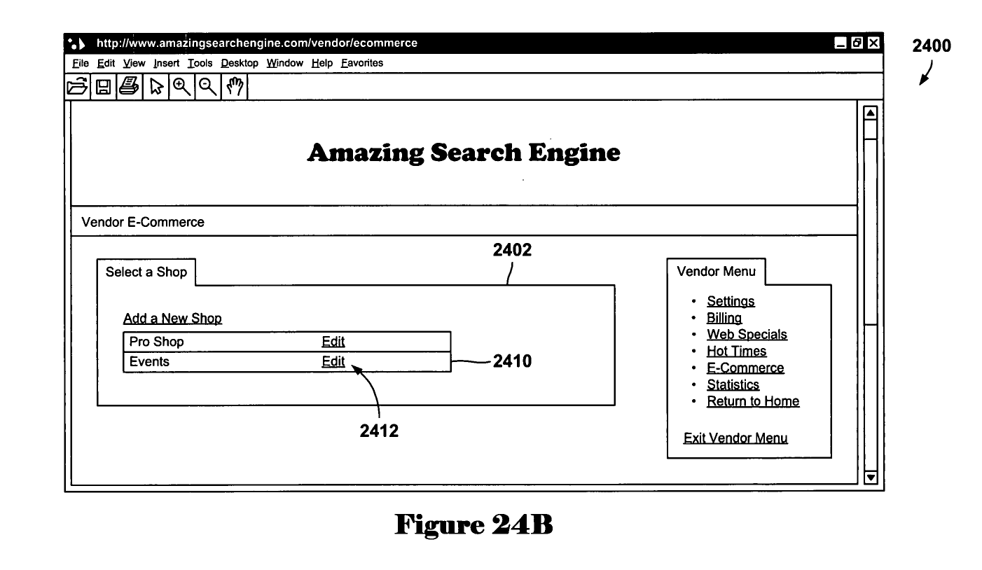

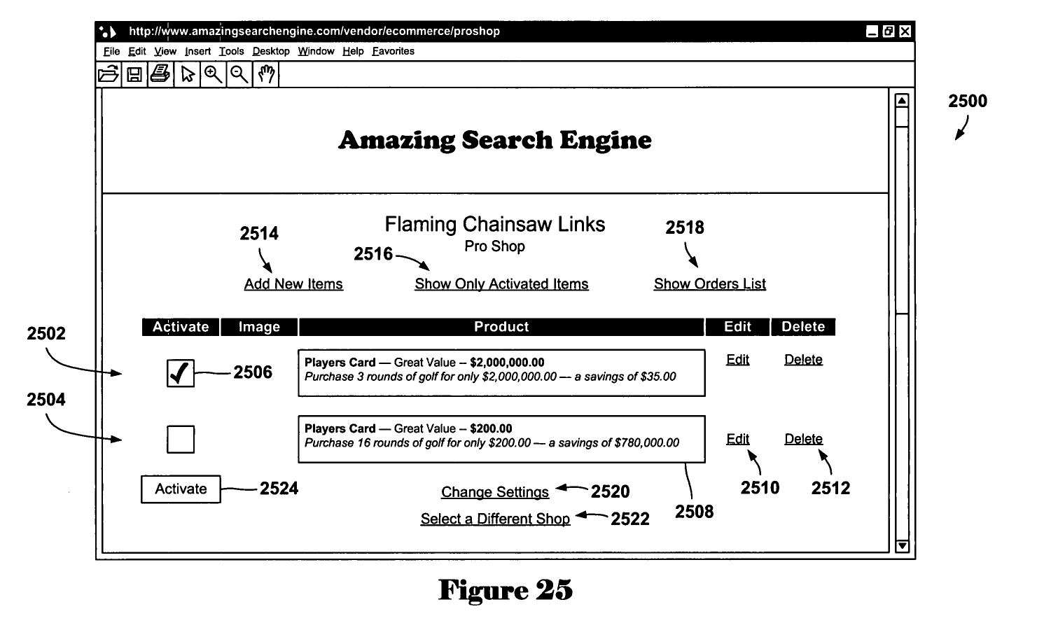

FIG. 24A shows an exemplary e-commerce-main-page that allows a premium vendor to manage retail items displayed within a pro shop page on a premium vendor-website listing by an e-commerce search engine and that represents one embodiment of the present invention. E-commerce main page 2400 includes a shop-selection panel 2402 and a vendor menu 1904. Shop-selection panel 2402 allows a premium vendor to manage a particular shop. In FIG. 24A, shop-selection panel 2402 contains pro-shop input window 2404. Pro-shop input window 2404 includes an edit link 2406 that allows a premium vendor to manage retail items displayed in the pro shop portion of the premium vendor-website listing by clicking on the edit link 2406 and is described below with reference to FIG. 25. Shop-selection input window 2402 also includes an add-a-new-shop link 2408 that allows a premium vendor to add another shop to shop-selection panel 2402.

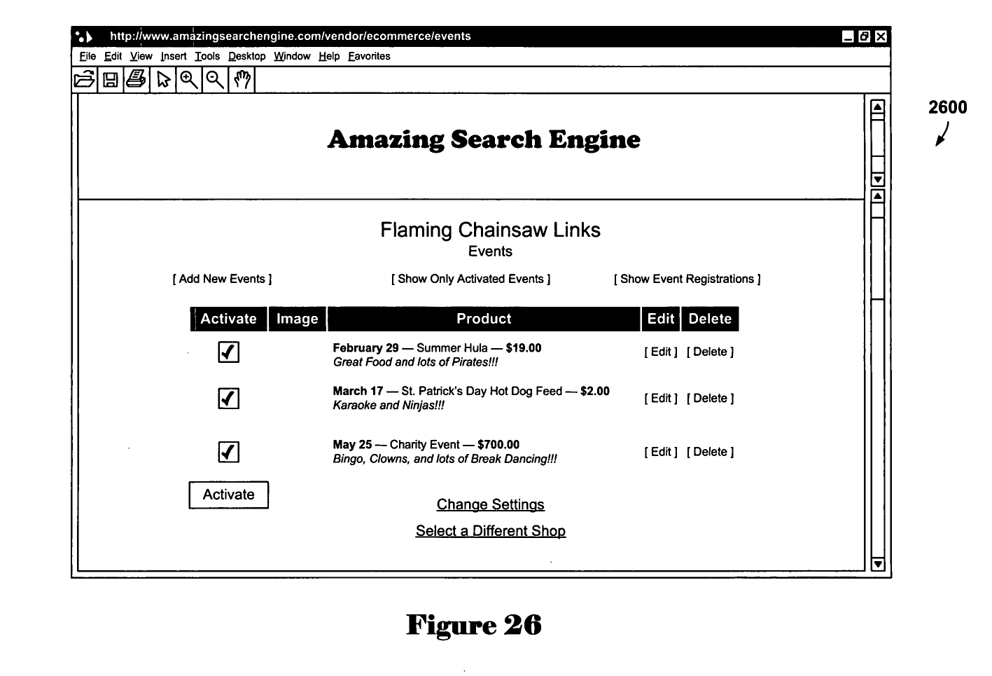

FIG. 24B shows an exemplary e-commerce-main page that allows a premium vendor to manage retail items displayed, on either a pro shop page or an events page, in association with a premium vendor-website listing by an e-commerce search engine and that represents one embodiment of the present invention. In FIG. 24B, e-commerce main page 2400 includes a shop-selection panel 2402 that contains an events input window 2410 with an edit link 2412 that allows a premium vendor to manage retail items displayed in the events portion of the premium vendor-website listing as described below with reference to FIG. 26.

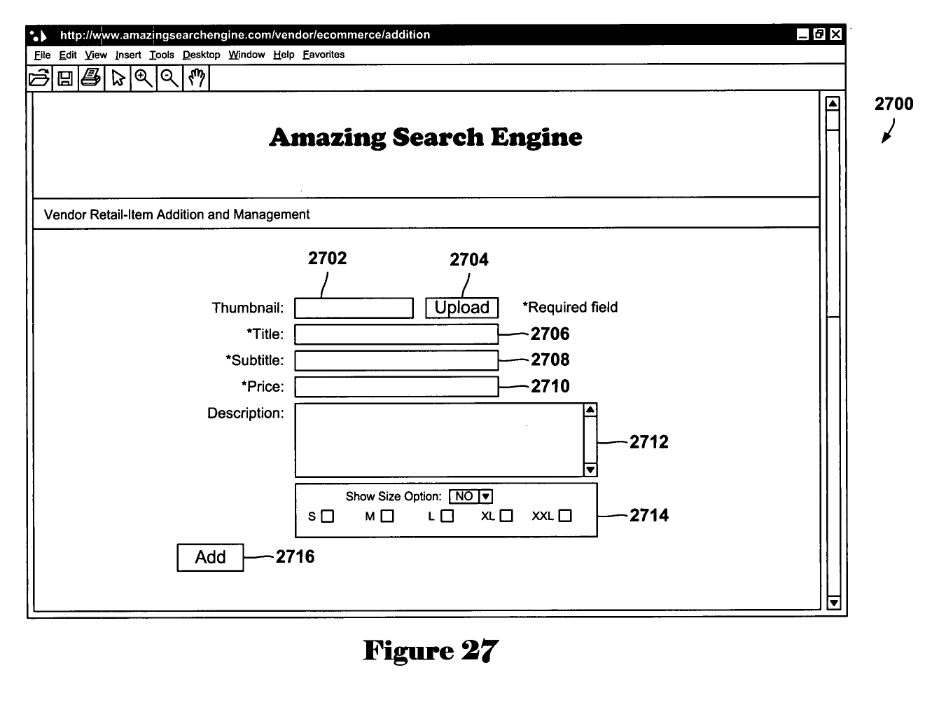

FIG. 25 shows an exemplary pro-shop-managing page that allows a premium vendor to manage retail items displayed on a pro shop page in association with a premium vendor-website listing by an e-commerce search engine that represents one embodiment of the present invention. Pro-shop-managing page 2500 includes two pro-shop retail items: a $2,000,000 player's card 2502, and a $200.00 player's card 2504. Each pro-shop retail item includes an activation box, such as activation box 2506, a name and description of the retail item, such as name and description 2508, an edit link, such as edit link 2510, and a delete-retail-item link, such as delete-retail-item link 2512. Edit link 2510 allows a premium vendor to edit the information included in the name and description of the retail item, as described below with reference to FIG. 27. An image indicator may also be included in pro-shop-managing page 2500 to indicate whether or not listed retail items contain an image displayed on the premium vendor-website listing.

Pro-shop-managing page 2500 also includes add-new-items link 2514, show-only-activated-items link 2516, show-orders-list link 2518, change-settings link 2520, and select-a-different-shop link 2522. Add-new-items link 2514 allows a premium vendor to add more items into the premium vendor-website listing in a similar manner as edit link 2510, and is also described below with reference to FIG. 27. Show-only-activated-items link 2516 displays pro-shop-managing page 2500 with only activated retail items shown. In FIG. 25, player's card 2502 is the only retail item activated. When show-only-activated-items link 2516 is clicked, player's card 2502 is the only retail item shown.

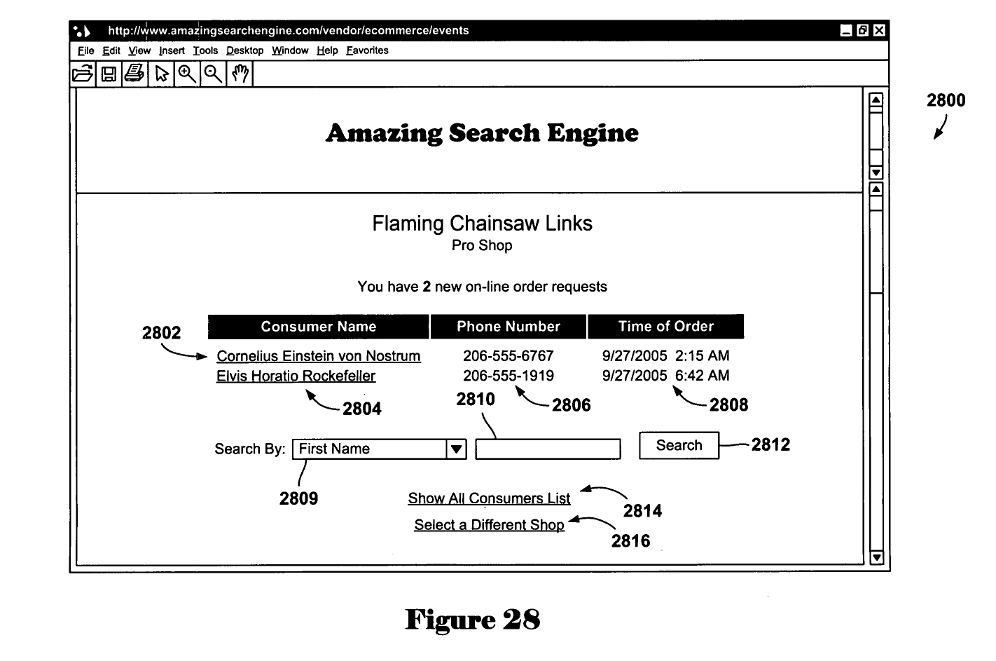

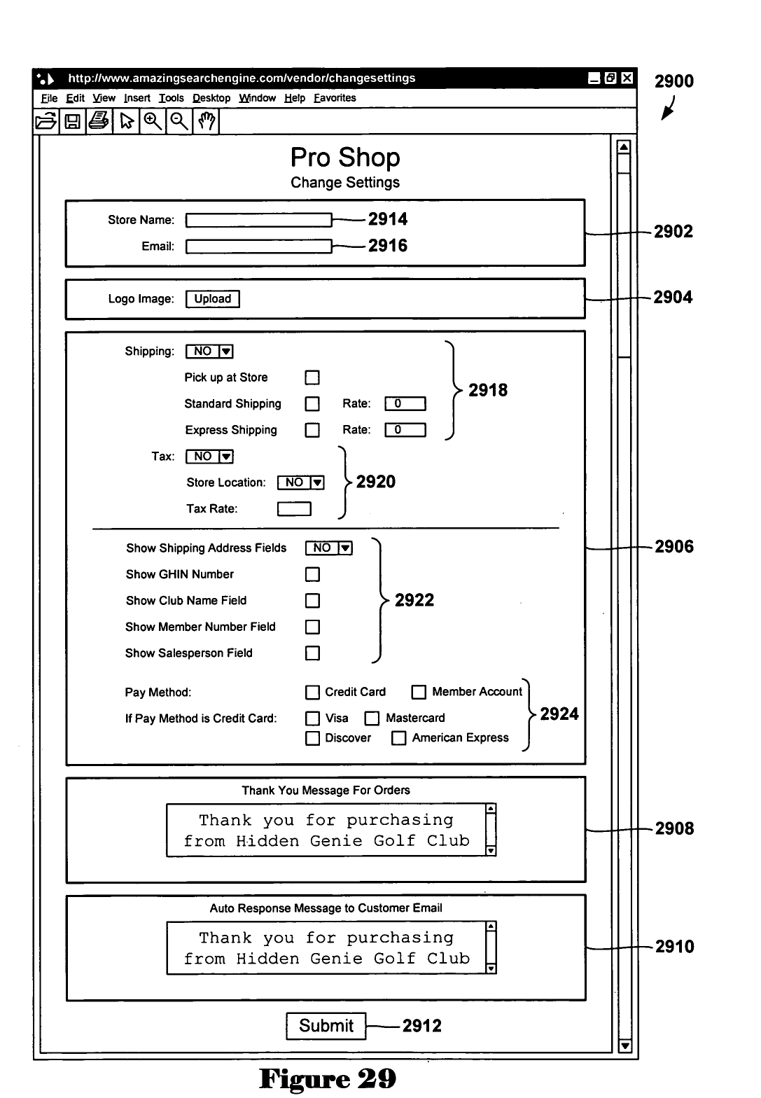

Show-orders-list link 2518 displays information regarding users that have previously ordered, or are currently ordering, retail items via the e-commerce search engine. Show-orders-list link 2518 is described below with reference to FIG. 28. Change-settings link 2520 allows premium vendors to change the displaying, ordering, and shipping of retail orders via the e-commerce search engine. For example, a premium vendor can change shipping rates charged to users, and change a thank you message sent to a user following the placement of an order. The change-settings link is described below with reference to FIG. 29. Select-a-different-shop link 2522 allows a different managing page to be displayed, such as an events-managing page. When a premium vendor is finished managing pro-shop retail items, clicking on the ACTIVATE button 2524 submits any new information to the e-commerce search engine. The new information is subsequently displayed on the premium vendor-website listing.

FIG. 26 shows an exemplary events-managing page that allows a premium vendor to manage retail items displayed on an events page in association with a premium vendor-website listing by an e-commerce search engine that represents one embodiment of the present invention. Events-managing page 2600 is similar to pro-shop managing page 2500 and allows a premium vendor to manage retail items contained on the events portion of a premium vendor-website listing.

FIG. 27 shows an exemplary retail-item-addition-and-management page that allows a premium vendor to add and manage retail items displayed on a pro shop page in association with a premium vendor-website listing by an e-commerce search engine that represents one embodiment of the present invention. Retail-item-addition-and-management page 2700 includes a thumbnail input window 2702 and corresponding UPDATE button 2704, a title input window 2706, a subtitle input window 2708, a price input window 2710, a description input window 2712, a size-option input window 2714, and an ADD button that submits any new information to the e-commerce search engine. The new information is subsequently displayed on the premium vendor-website listing. A premium vendor can input new or updated information into the input windows contained in retail-item-addition-and-management page 2700 to edit existing listings, or create new listings, for display on the vendor-website listing. Size-option input window can be used for several different applications, such as offering shirts or sale via the pro shop, or offering free shirts to users that purchase tournament registrations. In FIG. 27, retail-item-addition-and-management page 2700 is shown for a pro shop. However, retail-item-addition-and-management page 2700 can also be used to edit and add retail items to other e-commerce shops, such as an events shop.

FIG. 28 shows an exemplary list of people ordering retail items via a premium vendor-website listing displayed by an e-commerce search engine that represents one embodiment of the present invention. Order-list page 2800 shows two new ordering users: user 2802, and user 2804. Each new user listing is shown as a link and includes a user name, such as Elvis Horatio Rockefeller 2804, a phone number, such as phone number 2806, and a time of order, such as time-of-order 2808. A name with a link, such as Elvis Horatio Rockefeller 2804, can be clicked to display the transaction-related information input to the purchasing user's transaction page, such as the transaction page described above with reference to FIG. 6.

Order-list page 2800 also includes two search input windows 2809 and 2810 and a corresponding SEARCH button 2812. A premium vendor can use search input windows 2809 and 2810 to locate a specific pre-existing user. Order-list page 2800 further includes a show-all-users link 2814 and a select-a-different-shop link 2816. The show-all-users link 2814 shows a list of each user that has previously purchased retail items from a premium vendor via the e-commerce search engine. The select-a-different-shop link 2816 allows a premium vendor to view a display of other lists of new users that may have purchased retail items within another shop, such as an events shop.

FIG. 29 shows an exemplary pro-shop-settings-managing page that allows a premium vendor to manage selected settings for a pro shop associated with a premium vendor-website listing displayed by an e-commerce search engine that represents one embodiment of the present invention. Pro-shop-settings-managing page 2900 includes a store-name-and-email panel 2902, a logo-upload panel 2904, a shipping-information panel 2906, a thank-you-message panel 2908, an auto-response-message panel 2910, and a SUBMIT button 2912. The store-name-and-email panel 2902 contains a store-name input window 2912 and an email-address input window 2914 where a premium vendor can input updated information. The logo upload panel 2904 allows a premium vendor to have a mark displayed in a premium vendor-website listing and in other corresponding retail-related pages. The shipping-information panel 2906 contains: shipping input windows 2918 related to shipping retail items, tax input windows related to taxing user orders 2920, preference input windows 2922 for displaying various names, numbers, and other identifier input windows in user-order information, and payment-method input windows 2924 to determine acceptable methods of user payment.

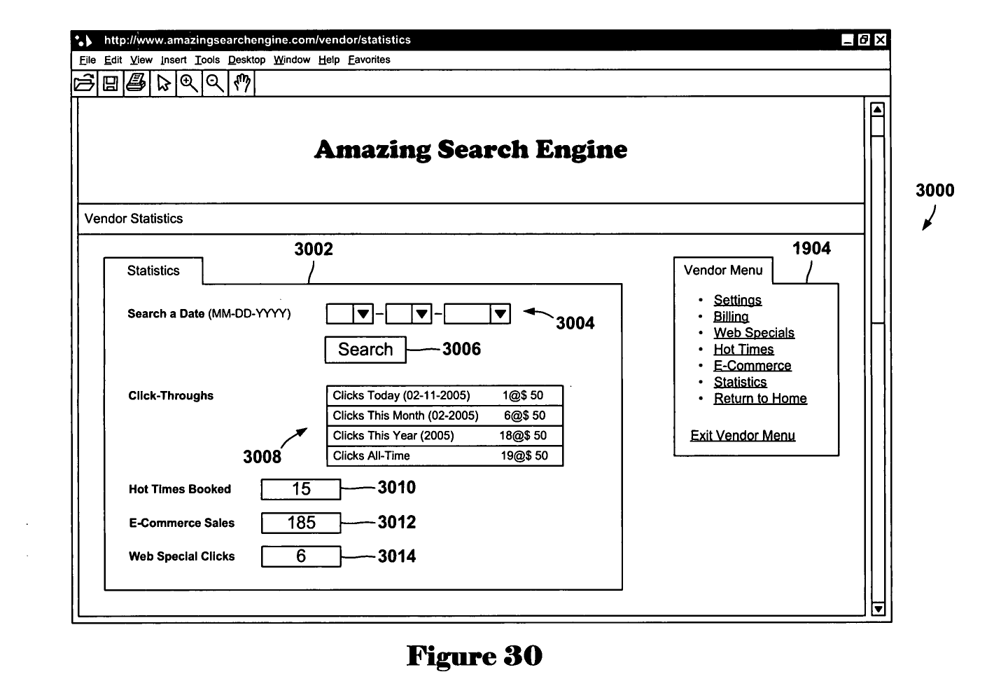

FIG. 30 shows an exemplary statistics page that allows a premium vendor to view the number of click-throughs and transactions occurring on a premium vendor-website listing displayed by an e-commerce search engine that represents one embodiment of the present invention. Statistics page 3000 includes statistics panel 3002 and vendor menu 1904. Statistics panel 3002 contains: three date-searching input windows 3004 to search a specific date and a corresponding SEARCH button 3006 to initiate the search, a group of click-through input windows 3008 displaying the number of click-throughs occurring throughout various time frames, a hot-times input window 3010 displaying the number of hot times booked, an e-commerce input window 3012 displaying the number of e-commerce retail items sold, and a web-special input window 3014 displaying the number of clicked-through web-specials. A premium vendor can use the information contained on statistics page 3000 to help maintain business records.

Additional modifications within the spirit of the invention will be apparent to those skilled in the art. For example, the e-commerce search engine has been described in terms of a golf-related E-commerce search engine. The e-commerce search engine can be adapted to many different types of industries. Many of the described pages were generalized for teaching purposes. Many additional features can appear on various pages, such as many different types of advertising. Additionally, many more links can be implemented to allow a user to more conveniently move from page to page without having to backtrack and/or retype information. The e-commerce search engine can be adapted so that users can shop for multiple retail items contained on multiple quick links within a single premium vendor-website listing while only inputting transaction-related information into a single transaction page. The number and types of quick links can be limitless. Premium vendors can be prompted regarding new sales in a variety of different ways. Two or more notification means can also be used simultaneously to facilitate the order processing. A premium vendor can receive notification via an email message from the e-commerce search engine. A premium vendor can also be notified via a prompt on the vendor-website-listing management page which immediately follows vendor login. A premium vendor can also be notified via the e-commerce web page.

The foregoing detailed description, for purposes of illustration, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description; they are not intended to be exhaustive or to limit the invention to the precise forms disclosed. Obviously many modifications and variation are possible in view of the above teachings. The embodiments were chosen and described in order to best explain the principles of the invention and its practical applications and to thereby enable others skilled in the art to best utilize the invention and various embodiments with various modifications as are suited to the particular use contemplated.

1. An Internet search engine with e-commerce functionality, the Internet search engine comprising:
a program that
generates a search page for receiving key-word searches input by a user;
responds to input to the search page by generating a list of annotated links to vendor websites, selected annotated links including quick links, each quick link including vendor-provided retail items and services for sale;
responds to user selection of a quick link that annotates a vendor's link by performing a retail transaction on behalf of the vendor; and
subsequently notifies the vendor of the retail transaction; and
wherein retail items include golf shoes, golf clubs, golf balls, golf-course coupons, golf equipment, golf-training materials, golf course apparel, and golf course memberships, and services include golf-course tee times, golf-course hot times, golf-course events, golf lessons, and golf tournaments.

2. The Internet search engine of claim 1 wherein an annotated link to a vendor website can be either a basic annotated link to a vendor website or a premium annotated link to a vendor website.

3. The Internet search engine of claim 2 wherein a number of quick links are displayed on a premium annotated link to a vendor website.

4. The Internet search engine of claim 1 wherein the Internet search engine responds to geographic information input as a key-word search on a generated search page by displaying annotated links to golf-course websites located in the vicinity of the input geographical information.

5. The Internet search engine of claim 1 wherein performing a retail transaction on behalf of the vendor includes generating a transaction page where a user can input shipping and billing information.

6. An Internet search engine with e-commerce functionality, the Internet search engine comprising:
a program that
generates vendor-registration pages that together compose a vendor-registration dialogue to allow a vendor to register an annotated link to the vendor's website with the Internet search engine; and
generates a vendor-control menu that allows a vendor to add, manage, and remove retail items listed for sale to users through the Internet search engine; and
wherein retail items include golf shoes, golf clubs, golf balls, golf-course coupons, golf equipment, golf training and equipment materials, golf course apparel, and golf course memberships, and services include golf-course tee times, golf-course hot times, golf-course events, golf lessons, and golf tournaments.

7. The Internet search engine of claim 6 wherein the vendor-control menu allows a vendor to input search criteria to influence when an annotated link to the vendor's website is displayed.

8. The Internet search engine of claim 6 wherein the vendor-control menu allows the vendor to set a monthly budget for maintaining an annotated link to the vendor's website on the Internet search engine.

9. The Internet search engine of claim 6 wherein the vendor-registration pages allow a vendor to register an annotated link to the vendor's website as a premium annotated link to the vendor's website.

10. The Internet search engine of the claim 9 wherein premium annotated links to a vendor's website further include quick links that annotate a vendor's link by performing a retail transaction on behalf of the vendor.

11. The Internet search engine of the claim 10 wherein the Internet search engine subsequently notifies a vendor of a retail transaction.

12. The Internet search engine of claim 9 wherein a vendor-control menu is accessed by vendors that have registered a premium annotated link to the vendor's website.

13. A method for locating and purchasing retail items from vendors via an Internet search engine, the method comprising:
generating a search page for receiving key-word searches input by a user;
responding to input to the search page by generating a list of annotated links to vendor websites, selected annotated links including quick links, each quick link including vendor-provided retail items and services for sale;
responding to user selection of a quick link that annotates a vendor's link by performing a retail transaction on behalf of the vendor; and
subsequently notifying the vendor of the retail transaction;

14. The method of claim 13 wherein an annotated link to a vendor website can be either a basic annotated link to a vendor website or a premium annotated link to a vendor website.

15. The method of claim 14 wherein quick links are displayed on a premium annotated link to a vendor website.

16. The method of claim 13 wherein performing a retail transaction on behalf of the vendor includes generating a transaction page where a user can input shipping and billing information.
